(19) United States
(12) Patent Application Publication
(10) Pub. No.: US 2022/0111347 A1
(43) Pub. Date: Apr. 14, 2022

(54) COLLOIDOSOMES AND POROUS MATERIALS BY PICKERING EMULSIONS

(71) Applicant: HE STATE OF ISRAEL, MINISTRY OF AGRICULTURE & RURAL DEVELOPMENT, AGRICULTURAL RESEARCH ORGANIZATION, Rishon Lezion (IL)

(72) Inventor: Guy MECHREZ, Adi (IL)

(21) Appl. No.: 17/556,264

(22) Filed: Dec. 20, 2021

Related U.S. Application Data
(63) Continuation of application No. PCT/IL2020/050692, filed on Jun. 21, 2020.
(60) Provisional application No. 62/864,041, filed on Jun. 20, 2019.

(51) Int. Cl. B01J 13/14; C09D 5/02; C09D 183/14; C09D 7/40; C09D 7/61; C01B 32/168

(52) U.S. Cl. CPC B01J 13/14; C09D 5/027; C09D 183/14; C01B 2202/22; C09D 7/61; C01B 32/168; C01B 2202/06; C09D 7/70

(57) ABSTRACT

A method for forming colloidosomes with a shell comprising carbon particles and inorganic nano-particles, are provided. Further, compositions emulsions and articles comprising the colloidosomes are provided.

### CROSS-REFERENCE TO RELATED APPLICATIONS

This application is a Bypass Continuation of PCT Patent Application No. PCT/IL2020/050692 having International filing date of Jun. 21, 2020, which claims the benefit of priority from U.S. Provisional Application No. 62/864,041 filed Jun. 20, 2019, the contents of which are incorporated herein in their entirety.

### FIELD OF THE INVENTION

The present invention is in the field of Pickering emulsions and colloidosomes.

### BACKGROUND OF THE INVENTION

The chemical inertness, thermal robustness, and the ability to easily introduce a diversity of functional groups on their surface, makes silica-based colloidosomes attractive for a broad range of applications.

Although the incorporation of CNTs in a silica-based structures is thus an important technological step to tailor CNT-based superstructures and to explore their applications, these are, however, hindered by their poor dispersibility and low interfacial compatibility in most common organic solvents and ceramic matrices. There is a need for efficient methods for the preparation of hybrid colloidosomes of multi-walled carbon nanotubes (MWCNTs) embedded in silica matrix.

### SUMMARY OF THE INVENTION

According to one aspect, there is provided a colloidosome comprising a shell encapsulating a core, wherein said shell comprises carbon particles in contact with a matrix comprising inorganic nano-particles covalently interconnected via a polymer; said polymer comprises a hydrophilic stabilizing moiety and a hydrophobic stabilizing moiety.

In one embodiment, a diameter of said colloidosome is in a range between 1 μm and 300 μm.

In one embodiment, a thickness of said shell is in a range between 50 nm and 700 nm.

In one embodiment, the inorganic particles are selected from the group consisting of silica, aluminum oxide, iron (II/III) oxide, zirconium oxide, titanium oxide, clay, and any combination thereof.

In one embodiment, the core comprises an aqueous solution, a water-immiscible solvent, or is void.

In one embodiment, the hydrophobic stabilizing moiety is derived from a hydrophobic stabilizing precursor molecule, and said hydrophilic stabilizing moiety is derived from a hydrophilic stabilizing precursor molecule.

In one embodiment, the hydrophilic stabilizing precursor molecule and said hydrophobic stabilizing precursor molecule comprise a polymerizable group.

In one embodiment, the polymerizable group is reactive towards said inorganic nano-particles.

In one embodiment, the polymerizable group comprises a hydrolysable silane.

In one embodiment, the hydrophilic stabilizing precursor molecule is represented by Formula 1: A-R—Si(X)₃, wherein A is selected from the group consisting of amino, hydroxy, alkoxy, thiol, thioalkyl, carboxy, sulfate, nitro, phosphate, ester, and amide or any combination thereof; R comprises an optionally substituted C5-C20 alkyl; X is selected from the group consisting of halo, alkoxy, and aryloxy or any combination thereof.

In one embodiment, the hydrophobic stabilizing precursor molecule is represented by Formula 2: B—R—Si(X)₃, wherein B is selected from the group consisting of aryl, alkyl, cycloalkyl, heteroaryl, halo, ether, and a fused ring or any combination thereof; R comprises an optionally substituted C5-C20 alkyl; X is selected from the group consisting of halo, alkoxy, and aryloxy or any combination thereof.

In one embodiment, the hydrophilic stabilizing precursor molecule is 3-Aminopropyltriethoxysilane (APTES) and said hydrophobic stabilizing precursor molecule is dodecyltriethoxysilane (DTES).

In one embodiment, a molar ratio between said hydrophilic stabilizing moiety and said hydrophobic stabilizing moiety within said colloidosome is between 5:1 to 1:5.

In one embodiment, a w/w ratio of said carbon particles to said inorganic particles is in the range between 10:1 and 1:10.

In one embodiment, the carbon particles are selected from the group consisting of single-walled carbon nano-tubes, multi-walled carbon nano-tubes, nano-diamonds, carbon black, fullerene, and graphene or any combination thereof or any combination thereof.

In another aspect, there is a composition comprising a colloidosome and a solvent, wherein: said colloidosomes comprising a shell encapsulating a liquid core; said shell comprises carbon particles in contact with a matrix comprising inorganic nano-particles covalently interconnected via a polymer; said polymer comprises a hydrophilic stabilizing precursor molecule and a hydrophobic stabilizing precursor molecule; and said liquid core and said solvent independently comprise an aqueous solvent, or a water immiscible solvent.

In one embodiment, the composition is selected from the group consisting of an emulsion, a dispersion, oil-in-oil emulsion, water-in-oil, and oil-in-water emulsion or any combination thereof.

In one embodiment, a concentration of the colloidosomes within the composition is between 10 and 90%.

In one embodiment, the colloidosomes have a diameter size in the range of 1 μm to 300 μm.

In one embodiment, the inorganic particles are selected from the group consisting of silica, aluminum oxide, iron (II/III) oxide, zirconium oxide, titanium oxide, clay, and any combination thereof.

In one embodiment, the hydrophilic stabilizing precursor molecule is 3-Aminopropyltriethoxysilane (APTES) and said hydrophobic stabilizing precursor molecule is dodecyltriethoxysilane (DTES).

In one embodiment, to molar ratio between said hydrophilic stabilizing precursor molecule and said hydrophobic stabilizing precursor molecule within said colloidosome is between 5:1 to 1:5.

In one embodiment, a w/w ratio of said carbon particles to said inorganic particles is in the range between 10:1 and 1:10.

In one embodiment, the carbon particles are selected from the group consisting of single-walled carbon nano-tubes, multi-walled carbon nano-tubes, nano-diamonds, carbon black, fullerene, and graphene or any combination thereof or any combination thereof.

In another embodiment, there is a method for forming the composition of any one of the invention, comprising:
a. providing a first dispersion the comprising the inorganic nano-particles and an aqueous solvent;
b. mixing said first dispersion with a second dispersion comprising the carbon particles and the water immiscible solvent, thereby forming a mixture;
c. adding a hydrophilic stabilizing precursor molecule and a hydrophobic stabilizing precursor molecule to said mixture under suitable conditions, thereby forming a Pickering emulsion.

In one embodiment, the Pickering emulsion comprises the colloidosome encapsulating the aqueous solvent, or the water immiscible solvent.

In one embodiment, the water immiscible solvent comprises toluene, heptane, cyclohexane, benzene, xylene, mesitylene, chlorobenzene, pentane, hexane, or any combination thereof.

In one embodiment, a concentration of the inorganic particles in the Pickering emulsion is between 0.2 and 10 wt %.

In one embodiment, a concentration of the carbon particles in the Pickering emulsion is between 0.01 and 10 wt %.

In one embodiment, the first dispersion/second dispersion ratio is in the range of 40:50 to 98:2.

In one embodiment, the suitable conditions comprise ultrasonication.

In one embodiment, the ultrasonication is performed between 30 seconds and 30 minutes.

In another aspect, there is an article comprising: a substrate in contact with a coating layer, wherein said coating layer comprises (i) a plurality of colloidosomes of any one of the invention or (ii) the composition of the invention.

In one embodiment, the substrate is selected from, a polymeric substrate, a glass substrate, a metallic substrate, a paper substrate, a brick wall, a sponge, a textile, a non-woven fabric, or wood.

In one embodiment, the coating is characterized by pores in the range of 0.5 μm to 5 μm.

In one embodiment, the coating is characterized by electrical conductivity.

In another aspect, there is a method of coating a substrate comprises providing a substrate and applying on said substrate the composition of the invention.

In one embodiment, the method further comprising curing said composition, thereby coating said substrate.

In one embodiment, the curing comprises providing said substrate under conditions sufficient for evaporating said aqueous solvent and said water immiscible solvent.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 presents a schematic illustration of the formation of multi walled carbon nanotube (MWCNT)/silica colloidosomes via solid-stabilized emulsion templating. The Pickering emulsion is stabilized by silica nanoparticles that assemble at the o/w interface; desorption is prevented by reacting silica with two silanes of opposite solubility. MWCNTs are co-assembling at the interface but will not act as stabilizers. Eventually, a core-shell structure is emerging from copolymerization of free and condensed silane monomers;

FIG. 2 presents a schematic illustration of the fluorescence labelling of CNTs with 6-Aminofluorescein; amidation of carboxylated CNTs with 6-AF proceeds in a two-step reaction using EDC as a cross-linker;

FIG. 3 presents a schematic illustration of the preparation of MWCNT/silica monolithic structures; the MWCNT/silica emulsion is drop-casted on a microscopic holder and dried for several hours at ambient conditions; after the solvent is evaporated, a solid composite structure is left, composed of a resinous polysiloxane-silica matrix in which MWCNTs are individually embedded;

FIG. 4 presents a picture of toluene-in-water mixtures prepared from 2 wt.-% silica NPs and 1 mg MWCNTs with 0.2 M APTES and DTES; the emulsions occasionally show the presence of MWCNT aggregates, as illustrated by black dots within the otherwise typically homogeneous, milky-grey mixtures; from left to right: o/w ratio=10:90, 20:80, 30:70, 50:50;

FIGS. 5A-5C present the mean droplet size analyses by bright field microscopy for the 1 mg MWCNT series: optical micrographs of MWCNT/silica PICKERING emulsions at different silica contents at o/w ratios; from left to right: o/w ratio=10:90, 20:80, 30:70, 50:50. Scale bar is 20 μm (FIG. 5A); the mean droplet size increases upon increasing oil vol.-% in the mixtures. Variances in between samples of different silica content were small and became significant just for 50:50 mixtures of the 2 wt.-% silica samples (FIG. 5B); the average droplet diameter is independent of the amount of silica NPs used in the experiments. An increase in the droplet diameter only appears for a sample composition of 2 wt.-% silica and 50:50 o/w ratio (FIG. 5C);

FIGS. 6A-6C present the mean droplet size analyzed by bright field microscopy for the 2 mg MWCNT series: optical micrographs of MWCNT/silica PICKERING emulsions at different silica contents at o/w ratios (FIG. 6A), from left to right: o/w ratio=10:90, 20:80, 30:70, 50:50. Scale bar is 20 μm; the mean droplet size increases upon increasing oil vol.-% in the mixtures. Variances in between samples of different silica content were small and became significant just for 50:50 mixtures (FIG. 6B); and other than expected, the average droplet diameter did not decrease linearly with increasing silica content (exception: 50:50 mixtures) (FIG. 6C);

FIGS. 7A-7C present the mean droplet size analyzed by bright field microscopy for the 5 mg MWCNT series: optical micrographs of MWCNT/silica PICKERING emulsions at different silica contents at o/w ratios, From left to right: o/w ratio=10:90, 20:80, 30:70, 50:50. Scale bar is 20 μm (FIG. 7A); the mean droplet size grows upon increasing oil vol.-% in the mixtures (FIG. 7B). For low silica concentrations, the variances in the droplet diameters were small. Only at the highest o/w ratio, changes became substantial. 2 wt.-% silica samples showed an overall less steep increase. Droplet sizes stay more or less constant at around 10 μm until an o/w ratio of 30:70. Their size is doubled for the 50:50 o/w sample; and as for the other series in this study, as well samples with a 5 mg MWCNT content did not show any clear decrease in the droplet diameter when the silica content was increased (exception again: 50:50 mixtures) (FIG. 7C);

FIGS. 8A-8B present the influence of the MWCNTs on the emulsion droplet size: bright field microscopy pictures for 0.5 wt.-% silica samples at various MWCNT content; from left to right: o/w=10:90, 20:80, 30:70, 50:50. Scale bar is 20 μm (FIG. 8A); despite small discrepancies, the mean droplet size is independent of the amount of MWCNTs, but shows a strong dependence on the oil-volume fraction used in the individual emulsions (FIG. 8B), significant differences only emerge at a 50:50 o/w ratio;

FIGS. 9A-9B present the influence of the MWCNTs on the emulsion droplet size: bright field microscopy images show the increase of the mean droplet diameter as a function of the o/w ratio for samples. Changes in between series with different MWCNT contents become more obvious for samples with a higher silica content. Sample compositions: 1 wt.-% silica, 1, 2 and 5 mg MWCNTs, 0.2 M APTES+DTES (FIG. 9A), and 2 wt.-% silica, 1, 2 5 mg MWCNTs, 0.2 M APTES+DTES (FIG. 9B). From left to right: o/w=10:90, 20:80, 30:70, 50:50. Scale bar is 20 μm;

FIG. 10 presents pictures of toluene-water mixtures with different inorganic nano-particle composition including bright field microscopy images: samples were prepared without the addition of APTES and DTES; the toluene phase was 50 vol.-%. None of the studied systems emulsified. Phase separation occurred immediately after sonication. Scale bar is 20 μm;

FIG. 11 presents pictures of toluene-water mixtures with different inorganic nano-particle composition and addition of 0.2 M DTES, including bright field microscopy images. During storage, a whitish, turbid layer appeared in some samples (indicated by arrow). None of the studied systems visually emulsified. However, few emulsion droplets have been found for the MWCNTCOOH/silica system in a middle that was formed during storage of 24 h. In all cases the toluene phase was 50 vol.-%. Scale bar is 20 μm;

FIGS. 12A-12B present the determination of the emulsion stability of an o/w MWCNT/silica Pickering emulsion: images of undisturbed emulsions immediately after emulsification and after one week of storage. Sample composition: 0.5 wt.-% silica, 1 mg MWCNT. From left to right: o/w=10:90, 20:80, 30:70, 50:50. Except for the 20:80 sample, the oil droplet sizes increased with time due to coalescence of the emulsion droplets. Scale bar is 20 μm (FIG. 12A); graph of the creaming index for emulsions stabilized by various concentrations of silica NPs as a function of the o/w ratio right after emulsification (FIG. 12B); the oil volume percentage did not show any substantial impact on the creaming behavior of the emulsions. Emulsions with a low silica content of 0.5 wt.-% creamed immediately (within 0.5 h) after emulsification. The amount of MWCNTs in all samples was 1 mg;

FIG. 13 presents pictures of toluene-water mixtures with different inorganic nano-particle composition and addition of 0.2 M APTES, including bright field microscopy images. Samples that included silica all emulsified. The MWCNT samples phase separated (pristine MWCNTs, sample C14) or showed a Bijel-like structure (carboxylated MWCNTs, C18). The toluene phase was 50 vol.-%. in all cases. Scale bar is 20 μm;

FIG. 14 presents pictures of toluene-water mixtures with different inorganic nano-particle composition and addition of 0.2 M APTES and DTES, including bright field microscopy images. Samples that included silica all emulsified. As well, carboxylated MWCNTs (sample C17) showed the formation of droplets. In case of C17, creaming occurs within the first 24 h, opposite to sample C5 where sedimentation could be observed. Pristine MWCNT samples did not emulsify, and phase separated immediately after sonication. The toluene phase was 50 vol.-%. in all cases. Scale bar is 20 μm;

FIGS. 15A-15C present pictures of the visualization of the complex colloidal layers at the emulsion interface; EDC mediated 6-aminofluorescein conjugation of carboxylated MWCNTs (FIG. 15A); 20 vol.-% toluene-in-water with 2.0 wt.-% SiO₂, 12 mg 6-AF conjugated MWCNTs, and 0.2 M APTES and DTES. The liquid cores are densely coated with a cross-linked polysiloxane layer with MWCNTs deposited inside the shell (FIG. 15B): and 50 vol.-% toluene-in-water with 2.0 wt.-% SiO₂, 1 mg MWCNTs, and 0.2 M APTES and DTES. Here, 6-AF is physisorbed to the MWCNTs, clearly showing the formation of a colloidal layer surrounding the droplet (FIG. 15C). Agglomerates of MWCNTs are visible inside the oil droplets. Some of the MWCNTs were transferred into the water phase, where an intensive aggregation was observed due to their inherent hydrophobicity. Control system made of 50 vol.-% toluene-in-water with 2.0 wt.-% SiO₂, and 0.2 M APTES and DTES. In the absence of MWCNTs no green fluorescent layer can be seen. 6-AF remains solved in the water phase without any adsorption to the silica particles. From left to right: Bright field image, confocal images (green and red channels), and overlaid channels.

FIG. 16 presents bright field microscopy image showing micron-sized crumpled shell structures. Crumpling occurs when the volatile toluene is evaporating upon drying (sample composition: 10 vol.-% toluene-in-water, 1 wt.-% SiO₂, 1 mg MWCNTs, and 0.2 M APTES and DTES);

FIGS. 17A-17D present Cryo-SEM micrographs of the MWCNT/silica emulsions: silica NPs are located at the interface and in the aqueous continuous phase. A polymeric smooth layer is formed at the inner side of the capsules with MWCNTs embedded in between outer and inner shell layers. Sample composition: 2 wt.-% silica, 1 mg MWCNTs, 10:90 o/w (v/v);

FIGS. 18A-18B present Cryo-SEM micrographs of ribbon-like polymeric structures: the structures are randomly branched and of varying width and length. They probably form upon copolymerization of hydrolysed silane monomers that remained unreacted (FIG. 18A); MWCNTs are embedded within the polymer matrix (FIG. 18B); and

FIGS. 19A-19D present pictures of micro- and nanostructures of the MWCNT/silica monoliths; (a, b) Drying of the emulsions generates solids with a complex, hierarchical architecture of open porosity and highly interconnected hollow spherical compartments of non-uniform size (FIGS. 19A-B); silica particle decorated MWCNTs are forming the skeleton (FIGS. 19C-D). They are embedded in a polysiloxane matrix (sample composition: (A, B) 10 vol.-% toluene-in-water with 1.0 wt.-% SiO2, 1 mg MWCNTs, and 0.2 M APTES and DTES; (C) 50 vol.-% toluene-in-water with 0.5 wt.-% SiO2, 1 mg MWCNTs, and 0.2 M APTES and DTES; (D) 10 vol.-% toluene-in-water with 0.5 wt.-% SiO2, 1 mg MWCNTs, and 0.2 M APTES and DTES).

FIG. 20 is a graph representing electrical resistance of the MWCNT/silica coatings as a function of the MWCNT content. Increasing the MWCNT amount reduced the electrical resistance of the coatings.

### DETAILED DESCRIPTION OF THE INVENTION

The present invention, in some embodiments thereof, relates to a colloidosome comprising a shell encapsulating a core, wherein the shell comprises carbon particles in contact with a matrix comprising inorganic nano-particles covalently interconnected via a polymer; wherein the polymer comprises a hydrophilic stabilizing moiety and a hydrophobic stabilizing precursor moiety.

In some embodiments, the shell comprises a polymeric matrix in contact with or bound to the carbon particles.

In some embodiments, the polymeric matrix comprises inorganic nano-particles covalently interconnected via a polymer. In some embodiments, the inorganic nano-particles are held together by the polymer. In some embodiments, the shell of the colloidosome is stabilized by the polymer. In some embodiments, the shell of the colloidosome is substantially solid.

In some embodiments, the polymer comprises hydrophilic stabilizing precursor molecule and a hydrophobic stabilizing precursor molecule. In some embodiments, the hydrophilic stabilizing precursor molecule and a hydrophobic stabilizing precursor molecule are polymerized so as to form the polymer. In some embodiments, the hydrophilic stabilizing precursor molecule and a hydrophobic stabilizing precursor molecule are polymerized via a condensation polymerization. Condensation polymerization is well-known in the art, and refers to a chain reaction between polymerizable monomers (also used herein as precursors), so as to generate a polymeric chain accompanied by elimination of a molecule (e.g. leaving group such as water, ethanol, methanol etc.).

In some embodiments, the hydrophobic stabilizing moiety is derived from a hydrophobic stabilizing precursor molecule, and the hydrophilic stabilizing moiety is derived from a hydrophilic stabilizing precursor molecule.

In some embodiments, the hydrophilic stabilizing precursor molecule and a hydrophobic stabilizing precursor molecule are polymerized or interconnected via a polymerizable group. In some embodiments, polymerization is initiated by a nucleophile. In some embodiments, polymerization is initiated by the inorganic nano-particle. In some embodiments, the inorganic nano-particle reacts with any of the hydrophilic stabilizing precursor molecule and the hydrophobic stabilizing precursor molecule so as to generate a generate a nucleophile. In some embodiments, the nucleophile is capable of reacting with another precursor, thereby forming the polymer. In some embodiments, the polymer is an inorganic polymer. In some embodiments, the polymer comprises an inorganic backbone formed by a plurality of polymerizable groups. In some embodiments, the inorganic backbone is derived form a condensation polymerization of the plurality of polymerizable groups. In some embodiments, the polymer comprises a polysiloxane backbone. In some embodiments, the polymer is in a form of a matrix comprising the inorganic nano-particles covalently bound to the polymer. In some embodiments, the inorganic nano-particles are held together by polymeric chains of the matrix. In some embodiments, the matrix comprises a plurality of interconnected polymeric chains.

In some embodiments, the carbon particle is in contact with the hydrophilic stabilizing moiety and/or with the hydrophobic stabilizing precursor molecule. In some embodiments, the carbon particle is in contact with the hydrophilic stabilizing moiety (e.g. APTES). In some embodiments, the carbon particle is covalently or non-covalently bound to the hydrophilic stabilizing moiety (e.g. APTES).

In some embodiments, the carbon particles are incorporated within the matrix. In some embodiments, the carbon particles are bound to the outer surface of the matrix. In some embodiments, the carbon particles are positioned in an interphase between an aqueous solvent (e.g. water phase) and the water-immiscible solvent (e.g. oil phase).

In some embodiments, the carbon particles are covalently bound to the hydrophilic stabilizing moiety (e.g. APTES). In some embodiments, the carbon particles are covalently bound to the polymerizable group and/or to the hydrophilic moiety of the hydrophilic stabilizing moiety (e.g. APTES). In some embodiments, the carbon particles are covalently bound to the hydrophilic stabilizing moiety via an amide bond. In some embodiments, the hydrophilic stabilizing moiety (e.g. DPTES) is within an interface between the aqueous solvent and the water immiscible solvent. In some embodiments, the hydrophilic moiety faces the aqueous solvent. In some embodiments, the hydrophobic moiety (e.g. C7-C15 alkyl) faces the water immiscible solvent. In some embodiments, the polymerizable group faces the inorganic particles and/or the aqueous solvent.

In some embodiments, the carbon particles comprise a particle selected from the group consisting of single-walled carbon nano-tubes, multi-walled carbon nano-tubes (MWCNT), nano-diamonds, carbon black, fullerene, and graphene or any combination thereof or any combination thereof.

In some embodiments, the carbon particles comprise MWCNT. In some embodiments, the carbon particles comprise chemically modified MWCNT. In some embodiments, chemically modified comprise a reactive group selected from carboxy, ester, anhydride, an activated ester (e.g. NETS-ester, acyl halide, etc.). In some embodiments, the carbon particles comprise carboxylated MWCNT. In some embodiments, the carbon particles comprise carboxylated MWCNT and non-modified MWCNT.

In some embodiments, the MWCNT comprise between 1-20%, between 1-3%, between 3-5%, between 5-7%, between 5-8%, between 7-10%, between 10-15%, between 15-20%, chemical modification (e.g. carboxy) including any range or value therebetween.

In some embodiments, the carbon particles are characterized by an average length of between 0.5 and 5 um, between 0.5 and 0.7 um, between 0.7 and 1 um, between 1 and 1.5 um, between 1.5 and 2 um, between 2 and 3 um, between 3 and 5 um, including any range therebetween.

In some embodiments, the carbon particles are characterized by an average diameter between 1 and 100 nm, between 1 and 5 nm, between 5 and 7 nm, between 7 and 10 nm, between 10 and 15 nm, between 15 and 20 nm, between 20 and 30 nm, between 30 and 50 nm, between 50 and 100 nm, including any range therebetween.

In some embodiments, the inorganic particles are selected from the group consisting of silica, aluminum oxide, iron (II/III) oxide, zirconium oxide, titanium oxide, clay, or any combination thereof. In some embodiments, the inorganic particles comprise hydroxy groups on the outer surface thereof. In some embodiments, the terms “inorganic particles” and “inorganic nano-particles” are used herein interchangeably.

In some embodiments, the inorganic particles comprise silica nanoparticles. In some embodiments, the inorganic particles comprise fumed silica nanoparticles. In some embodiments, the inorganic particles are chemically modified.

In some embodiments, the size of the inorganic particles is between 1 and 800 nm, between 1 and 5 nm, between 5 and 7 nm, between 7 and 10 nm, between 10 and 50 nm, between 50 and 100 nm, between 100 and 200 nm, between 200 and 300 nm, between 300 and 400 nm, between 400 and 500 nm, between 500 and 600 nm, between 600 and 800 nm, including any range therebetween.

In some embodiments, the hydrophilic stabilizing precursor molecule and said hydrophobic stabilizing precursor molecule comprise a polymerizable group.

In some embodiments, the hydrophilic stabilizing precursor molecule and the hydrophobic stabilizing precursor molecule are characterized by a reactivity towards each other. In some embodiments, the hydrophilic stabilizing precursor molecule and the hydrophobic stabilizing precursor molecule comprise a polymerizable group. In some embodiments, the hydrophilic stabilizing precursor molecule and the hydrophobic stabilizing precursor molecule comprise are capable of polymerization via the reactive group.

In some embodiments, the polymer comprises at least partially polymerized hydrophilic stabilizing precursor molecule and hydrophobic stabilizing precursor molecule. In some embodiments, the polymer comprises non-polymerized hydrophilic stabilizing precursor molecule and hydrophobic stabilizing precursor molecule.

In some embodiments, the reactive group has a reactivity towards the inorganic particles. In some embodiments, the reactive group is capable of reacting with the hydroxy group of the inorganic particles. In some embodiments, the hydrophilic stabilizing precursor molecule is capable of reacting with the inorganic particle(s). In some embodiments, the hydrophilic stabilizing precursor molecule is capable of initiating the polymerization of any one of the hydrophilic stabilizing precursor molecules and the hydrophobic stabilizing precursor molecules.

In some embodiments, the hydrophilic stabilizing precursor molecule comprises a basic group (e.g. amine, guanidine, imine, urea).

In some embodiments, the polymerizable group comprises a hydrolysable group. In some embodiments, the polymerizable group is a hydrolysable silane group.

In some embodiments, the hydrolysable silane group comprises a leaving group displaced by water or alkoxyde. In some embodiments, the hydrolysable silane group is selected from alkyxosilane, and halosilane. In some embodiments, the hydrolysable silane group is trialkoxysilane. In some embodiments, the hydrolysable silane group is triaryloxysilane.

In some embodiments, the hydrophilic stabilizing precursor molecule is represented by Formula 1: A-R—Si(X)₃, wherein A is selected from the group consisting of amino, hydroxy, alkoxy, thiol, thioalkyl, carboxy, sulfate, nitro, phosphate, ester, and amide or any combination thereof; R comprises an optionally substituted C5-C20 alkyl; X is selected from the group consisting of halo, alkoxy, and aryloxy or any combination thereof. In some embodiments, A is a hydrophilic moiety (e.g. a polar group). In some embodiments, A is amino (optionally alkylated with one or more C1-C5 alkyls).

In some embodiments, the hydrophobic stabilizing precursor molecule is represented by Formula 2: B—R—Si(X)₃, wherein B is selected from the group consisting of aryl, alkyl, cycloalkyl, heteroaryl, halo, ether, and a fused ring or any combination thereof; R comprises an optionally substituted C5-C20 alkyl; X is selected from the group consisting of halo, alkoxy, and aryloxy or any combination thereof.

In some embodiments, R comprises an optionally substituted C5-C20 alkyl, C5-C20 alkyl, C5-C7 alkyl, C7-C10 alkyl, C10-C15 alkyl, C15-C20 alkyl, including any range or value therebetween. In some embodiments, R comprises 3, 4, 5, 6, or 7 methylene units. In some embodiments, R comprises 8, 9, 10, 11, 12, 13, 14 or 15 methylene units

In some embodiments, X comprises C1-C10 alkoxy, C1-C2 alkoxy, C2-C4 alkoxy, C4-C6 alkoxy, C6-C8 alkoxy, C8-C10 alkoxy, including any range or value therebetween.

In some embodiments, X comprises ethoxy or methoxy.

In some embodiments, hydrophilic stabilizing precursor molecule is a hydrophilic surfactant. In some embodiments, hydrophilic stabilizing precursor molecule is a hydrophilic organosilane. In some embodiments, hydrophilic stabilizing precursor molecule is a hydrophilic alkoxysilane. In some embodiments, hydrophilic stabilizing precursor molecule is a hydrophilic trialkoxysilane. In some embodiments, hydrophilic stabilizing precursor molecule is an amino trialkoxysilane. In some embodiments, hydrophilic stabilizing precursor molecule is 3-Aminopropyltriethoxysilane (APTES).

In some embodiments, hydrophobic stabilizing precursor molecule is a hydrophobic surfactant. In some embodiments, hydrophobic stabilizing precursor molecule is a hydrophobic organosilane. In some embodiments, hydrophobic stabilizing precursor molecule is a hydrophobic alkoxysilane. In some embodiments, hydrophobic stabilizing precursor molecule is a hydrophobic trialkoxysilane. In some embodiments, hydrophobic stabilizing precursor molecule is a trialkoxysilane. In some embodiments, the hydrophobic stabilizing precursor molecule is dodecyltriethoxysilane (DTES).

In some embodiments, the colloidosomes have a diameter size in the range of 1 μm to 300 μm, 1 μm to 280 μm, 1 μm to 250 μm, 1 μm to 200 μm, 1 μm to 180 μm, 1 μm to 150 μm, 2 μm to 300 μm, 5 μm to 300 μm, 10 μm to 300 μm, 15 μm to 300 μm, 20 μm to 300 μm, 2 μm to 250 μm, 2 μm to 200 μm, 2 μm to 180 μm, 2 μm to 150 μm, 5 μm to 250 μm, 5 μm to 200 μm, 5 μm to 180 μm, 5 μm to 150 μm, 10 μm to 250 μm, 10 μm to 200 μm, 10 μm to 180 μm, or 10 μm to 150 μm, including any range therebetween.

In some embodiments, the composition comprises a colloidosome comprising a shell comprising carbon particles and colloidal particles, and having a thickness in the range of 50 nm to 700 nm, 50 nm to 600 nm, 50 nm to 500 nm, 50 nm to 400 nm, 50 nm to 300 nm, 70 nm to 700 nm, 80 nm to 700 nm, 90 nm to 700 nm, 100 nm to 700 nm, 150 nm to 700 nm, 200 nm to 700 nm, 200 nm to 600 nm, 200 nm to 500 nm, or 200 nm to 400 nm, including any range therebetween.

In some embodiments, the core of the colloidosomes is void.

In some embodiments, the colloidosome encapsulates a liquid. In some embodiments, the liquid is selected from the group consisting of an aqueous solution, a water-immiscible solvent, an oil, a polymer, a chemical compound, a liquid, or any combination thereof.

In some embodiments, a molar ratio between said hydrophilic stabilizing precursor molecule and the hydrophobic stabilizing precursor molecule within the colloidosome is between 5:1 to 1:5, between 5:1 to 3:1, between 3:1 to 2:1, between 2:1 to 1:1, between 1:1 to 1:2, between 1:2 to 1:3, between 1:3 to 1:5, including any range therebetween.

In some embodiments, a w/w ratio of the carbon particles to the inorganic particles is in a range between 10:1 and 1:10, between 10:1 and 8:1, between 8:1 and 6:1, between 6:1 and 4:1, between 4:1 and 2:1, between 2:1 and 1:1, between 1:1 and 1:2, between 1:2 and 1:3, between 1:3 and 1:4, between 1:4 and 1:6, between 1:6 and 1:8, between 1:8 and 1:2, including any range therebetween.

### The Composition

According to some embodiments, the present invention relates to a composition comprising colloidosomes and a solvent, wherein the colloidosomes comprising a shell encapsulating a liquid core; the shell comprises carbon particles in contact with a matrix comprising inorganic nano-particles covalently interconnected via a polymer; the polymer comprises a hydrophilic stabilizing precursor molecule and a hydrophobic stabilizing precursor molecule; and the liquid core and the solvent independently comprise an aqueous solvent, or a water immiscible solvent.

In some embodiments, the colloidosomes are as described herein. In some embodiments, the water immiscible solvent comprises a non-polar organic solvent. In some embodiments, the water immiscible solvent comprises any of toluene, heptane, cyclohexane, benzene, xylene, mesitylene, chlorobenzene, pentane, hexane, or any combination thereof.

In some embodiments, the composition comprises an emulsion comprising a plurality of colloidosomes in the interface of a first solution and a second solution, wherein the colloidosomes comprise a shell comprising carbon particles and colloidal particles.

In some embodiments, the composition is selected from the group consisting of an emulsion, a dispersion, oil-in-oil emulsion, water-in-oil, and oil-in-water emulsion or any combination thereof.

In some embodiments, a weight per weight (w/w) concentration of the colloidosomes within the composition is between 10 and 90%, between 5 and 10%, between 10 and 15%, between 15 and 20%, between 20 and 30%, between 30 and 40%, between 40 and 50%, between 50 and 60%, between 60 and 70%, between 70 and 90%, between 90 and 95%, including any range therebetween.

In some embodiments, the emulsion comprises two or more stabilizing precursor molecules with opposite polarity. In some embodiments, the emulsion comprises one or more polymers. In some embodiments, the inorganic nano-particles are functionalized with a polymer.

According to some embodiments, the present invention relates to a composition comprising a colloidosome having a diameter in the range of 1 μm to 300 μm, wherein the colloidosome comprises a shell comprising carbon particles and colloidal particles, and having a thickness in the range of 50 nm to 700 nm.

In some embodiments, the carbon particles are incorporated in the matrix of the colloidal particles.

As used herein, the term “matrix” refers to a continuous phase in a material.

In some embodiments, the inorganic nano-particles are selected from the group consisting of polymer particles, metallic particles, semi-conducting particles, emulsion drops, inorganic particles, and any combination thereof.

In some embodiments, the inorganic particles are selected from the group consisting of silica, titanium oxide, clay, and any combination thereof.

In some embodiments, the carbon particles comprise carbon nanotubes.

In some embodiments, the inorganic nano-particles comprise a shell incorporating carbon nanotubes and silica nanoparticles, and a core. In some embodiments, the inorganic nano-particles comprise a shell incorporating multi walled carbon nanotube (MWCNTs) and silica nanoparticles, and a core. In some embodiments, the MWCNTs are self-assembled within the silica nanoparticles. The MWCNTs are self-assembled within the silica nanoparticles without targeted chemistry (e.g. polymerization). In some embodiments the core is void. In some embodiments, the core encapsulates a material as described herein.

According to some embodiments, the present invention relates to a porous composition comprising a plurality of carbon particles incorporated in a colloidal particle matrix, and having a porous size in the range of 0.5 μm to 5 μm.

In some embodiments, the porous composition has a porous size in the range of 0.5 μm to 5 μm, 0.7 μm to 5 μm, 0.8 μm to 5 μm, 1 μm to 5 μm, 1.5 μm to 5 μm, 2 μm to 5 μm, 1 μm to 4.5 μm, 1 μm to 4 μm, 1 μm to 3.5 μm, or 1 μm to 3 μm, including any range therebetween.

In some embodiments, the porous composition comprises secondary pores with a porous size in the range of 50 nm to 500 nm, 50 nm to 400 nm, 50 nm to 300 nm, 50 nm to 200 nm, 80 nm to 500 nm, 100 nm to 500 nm, 150 nm to 500 nm, or 200 nm to 500 nm, including any range therebetween.

In some embodiments, a porous composition comprising a plurality of carbon particles incorporated in a colloidal particle matrix as described herein, has improved mechanical properties when compared to the corresponding composition without the carbon particles. In some embodiments, a porous composition comprising a plurality of carbon particles incorporated in a colloidal particle matrix as described herein, has improved electrical properties when compared to the corresponding composition without the carbon particles.

In some embodiments, a porous composition is obtained by drop-coating and air-drying of the emulsions according to the present invention. In some embodiments, a porous composition comprises porous MWCNT/silica composites with 3D hierarchical open architectures.

According to some embodiments, there is an article comprising a substrate in contact with a coating layer, wherein the coating layer comprises a plurality of colloidosomes of the invention or the composition of the invention.

In some embodiments, the substrate is selected from, a polymeric substrate, a glass substrate, a metallic substrate, a paper substrate, a brick wall, a sponge, a textile, a non-woven fabric, or wood.

In some embodiments, there is a method of coating a substrate comprises providing a substrate and applying on the substrate the composition of the invention. In some embodiments, applying is by casting, brushing, spraying, printing, rolling, dip coating, spray coating, blowing, and extruding or any combination thereof. Other coating methods are well-known in the art.

In some embodiments, the further comprising curing said composition. In some embodiments, curing is by drying (such as by conventional drying, heat drying etc.). In some embodiments, curing is by evaporating the aqueous solvent and the water immiscible solvent. In some embodiments, evaporating is by applying any of thermal radiation, IR radiation and/or vacuum. In some embodiments, thermal radiation and/or IR radiation is sufficient for substantially evaporating the aqueous solvent and the water immiscible solvent.

In some embodiments, the cured composition or coating comprises less than 10%, less than 5%, less than 3%, less than 2%, less than 1%, less than 0.5%, less than 0.1%, less than 0.05% w/w residual solvent.

In some embodiments, the cured composition is stably bound (e.g. non-covalently) to the substrate.

In some embodiments, curing comprises providing said substrate under conditions sufficient for evaporating of the first dispersion and the second dispersion.

In some embodiments, the coating is characterized by pores in the range of 0.5 μm to 5 μm, between 0.5 and 5 μm, between 0.5 and 1 μm, between 1 and 1.5 μm, between 1.5 and 2 μm, between 2 and 3 μm, between 3 and 5 μm, including any range therebetween.

In some embodiments, the w/w concentration of the carbon particles (e.g. MWCNT) within the coating is between 0.05 and 20%, between 0.05 and 0.1%, between 0.1 and 0.5%, between 0.5 and 1%, between 1 and 3%, between 3 and 5%, between 5 and 7%, between 7 and 10%, between 10 and 15%, between 15 and 20%, including any range therebetween.

In some embodiments, the coating is characterized by electrical conductivity. In some embodiments, the electrical conductivity is predetermined b the concentration of the carbon particles (e.g. MWCNT). In some embodiments, the coating is characterized by reduced electrical resistance, compared to the coating devoid of carbon particles (e.g. MWCNT).

In some embodiments, the electrical resistance is reduced by at least 50%, at least 100%, at least 150%, at least 200%, at least 300%, at least 400%, at least 500%, including any range therebetween.

In some embodiments, the electrical resistance is reduced by increasing concentration of carbon particles (e.g. MWCNT) within the coating. In some embodiments, the electrical resistance is between 1 and 10 Ohm, between 1 and 2 Ohm, between 2 and 5 Ohm, between 5 and 7 Ohm, between 7 and 10 Ohm, including any range therebetween.

In some embodiments, the electrical resistance is as described in the Examples section.

In some embodiments, the present invention relates to an article comprising a composition as described herein. In some embodiments, an article comprises a conductive coating of the composition as described herein. Articles according to the present invention include sensors, coatings, or nanoelectronic devices. In some embodiments, the article comprises a “printable” electronic component. In some embodiments, the article comprises transistors, solar cells, light emitting diodes, and similar devices. In some embodiments, the article is a light emitting diode, a photovoltaic device, a transistor, a chemristor, or a chemical sensor. In some embodiments, the article is a conductive coating (e.g. a display).

The term “aggregate” as used herein refers to a distance decrease between particles. In an embodiment, interaction between particles may occur. Aggregates of particles may have two or more individual particles combined into one grouping. Aggregation may occur spontaneously in a sample or subject or it may be controlled by a chemical or biological process. Aggregation may occur after injection of individual particles or delivery of individual particles to sample or particles may be aggregated prior to delivery.

The term “silica” as used here refers to a structure containing at least the following the elements: silicon and oxygen. Silica may have the fundamental formula of SiO₂ or it may have another structure including SiₓO_{y} (where x and y can each independently be about 1 to 10). Additional elements including, but not limited to, carbon, nitrogen, sulfur, phosphorus, or ruthenium may also be used. Silica may be a solid particle or it may have pores.

The term “droplet” as used herein, refers to an isolated portion of a first fluid that is surrounded by a second fluid. It is to be noted that a droplet is not necessarily spherical; but may assume other shapes as well, for example, depending on the external environment. In some embodiments, the droplet has a minimum cross-sectional dimension that is substantially equal to the largest dimension of the channel perpendicular to fluid flow in which the droplet is located. In some cases, the droplet may be a vesicle, such as a liposome, a colloidosome, or a polymersome.

The fluidic droplets may have any shape and/or size. Typically, monodisperse droplets are of substantially the same size. The shape and/or size of the fluidic droplets can be determined, for example, by measuring the average diameter or other characteristic dimension of the droplets. The “average diameter” of a plurality or series of droplets is the arithmetic average of the average diameters of each of the droplets. Those of ordinary skill in the art will be able to determine the average diameter (or other characteristic dimension) of a plurality or series of droplets, for example, using laser light scattering, microscopic examination, or other known techniques. The average diameter of a single droplet, in a non-spherical droplet, is the diameter of a perfect sphere having the same volume as the non-spherical droplet.

In some embodiments, the average diameter of a droplet (and/or of a plurality or series of droplets) is, less than about 1 mm, less than about 500 micrometers, less than about 200 micrometers, less than about 100 micrometers, less than about 75 micrometers, less than about 50 micrometers, less than about 25 micrometers, less than about 10 micrometers, or less than about 5 micrometers, including any value therebetween. In some embodiments, the average diameter is at least about 1 micrometer, at least about 2 micrometers, at least about 3 micrometers, at least about 5 micrometers, at least about 10 micrometers, at least about 15 micrometers, or at least about 20 micrometers, including any value therebetween.

In some embodiments, the invention comprises a kit comprising a first compartment and a second compartment. In some embodiments, the first compartment comprises a dispersion comprising an aqueous solution and the inorganic nanoparticles. In some embodiments, the first compartment further comprises the hydrophobic stabilizing precursor molecule (e.g. DTES). In some embodiments, the first compartment further comprises carbon particles (e.g. MWCNT, and/or carboxylated MWCNT).

In some embodiments, the first compartment comprises a solution of the hydrophilic stabilizing precursor molecule (e.g. APTES). In some embodiments, the first compartment further comprises any of the hydrophobic stabilizing precursor molecule (e.g. DTES) and the carbon particles (e.g. MWCNT, and/or carboxylated MWCNT).

### The Method

According to some embodiments, the present invention relates to a method for forming a composition comprising colloidosomes dispersed within a solvent, comprising:
a. providing a first dispersion comprising the inorganic nano-particles and an aqueous solvent;
b. mixing the first dispersion with a second dispersion comprising the carbon particles and the water immiscible solvent, thereby forming a mixture;
c. adding a hydrophilic stabilizing precursor molecule and a hydrophobic stabilizing precursor molecule to the mixture under suitable conditions, thereby forming a Pickering emulsion.

In some embodiments, the method is for manufacturing the composition of the invention. In some embodiments, the Pickering emulsion comprises the colloidosome encapsulating the aqueous solvent, and/or the water immiscible solvent.

In some embodiments, the method for manufacturing the colloidosome of the invention comprises steps a to c and further comprises the step of evaporating the aqueous solvent and the water immiscible solvent.

In some embodiments, the step c of the method is for polymerizing hydrophilic stabilizing precursor molecules and hydrophobic stabilizing precursor molecules. In some embodiments, the step c of the method is for forming the polymer comprising the hydrophobic stabilizing moiety and the hydrophilic stabilizing moiety. In some embodiments, the step c of the method is for forming the matrix.

As used herein, the term “Pickering emulsion” refers to an emulsion that utilizes solid particles as a stabilizer to stabilize droplets of a substance, in a dispersed phase in the form of droplets dispersed throughout a continuous phase, which comprises an aqueous medium.

In some embodiments, there is a method for forming colloidosomes with a shell comprising carbon particles and colloidal particles, comprising: a. dispersing the inorganic nano-particles in a first solution, thereby forming a dispersion; b. mixing the dispersion with a second solution comprising the carbon particles, thereby forming a Pickering emulsion; c. adding two or more stabilizing precursor molecules with opposite polarity to the Pickering emulsion; and d. applying ultrasonication.

In some embodiments, the method further comprises the step of evaporating the first solution and the second solution.

In some embodiments, the carbon particles are incorporated in the matrix of the colloidal particles.

In some embodiments, then inorganic nano-particles are selected from the group consisting of polymer particles, metallic particles, semi-conducting particles, emulsion drops, inorganic particles, and any combination thereof.

In some embodiments, the inorganic particles are selected from the group consisting of silica, titanium oxide, clay, and any combination thereof.

In some embodiments, the carbon particles comprise carbon nanotubes.

In some embodiments, the first solution comprises an aqueous solution.

In some embodiments, the second solution comprises toluene, heptane, cyclohexane, benzene, xylene, mesitylene, chlorobenzene, pentane, hexane, or any combination thereof.

In some embodiments, the two or more stabilizing precursor molecules with opposite polarity comprise organosilanes.

In some embodiments, the organosilanes comprise 3-Aminopropyltriethoxysilane (APTES) and dodecyltriethoxysilane (DTES).

In some embodiments, the two or more stabilizing precursor molecules with opposite polarity are used in a ratio of 0.5:1 to 1:1.

In some embodiments, the content of the inorganic nano-particles is in the range of 0.2 wt % to 10 wt %.

In some embodiments, the content of the carbon particles is in the range of 0.5 mg to 10 mg.

In some embodiments, the first solution/second solution ratio is in the range of 40:50 to 98:2.

In some embodiments, the ultrasonication is performed between 30 seconds and 30 minutes.

In some embodiments, the colloidosomes have a diameter size in the range of 1 μm to 300 μm.

In some embodiments, the core of the colloidosomes is void.

In some embodiments, the core of the colloidosomes comprises an oil, a polymer, a chemical compound, a liquid, or any combination thereof.

According to one aspect, there is provided an emulsion comprising a plurality of colloidosomes in the interface of a first solution and a second solution, wherein the colloidosomes comprise a shell comprising carbon particles and colloidal particles.

In some embodiments, the carbon particles are incorporated in the matrix of the colloidal particles.

In some embodiments, the emulsion comprises two or more stabilizing precursor molecules with opposite polarity.

In some embodiments, the emulsion comprises one or more polymers.

In some embodiments, the inorganic nano-particles are functionalized with a polymer.

According to one aspect, there is provided a composition comprising a colloidosome having a diameter in the range of in the range of 1 μm to 300 μm, wherein the colloidosome comprises a shell comprising carbon particles and colloidal particles, and having a thickness in the range of 50 nm to 700 nm.

As used herein, the term “emulsion” refers to a combination of at least two fluids, where one of the fluids is present in the form of droplets in the other fluid. The term “emulsion” includes microemulsions.

As used herein, the term “solvent” refers to a liquid that can dissolve another substance, and that is not a polymerizer.

As used herein, the term “fluid” refers to a substance that tends to flow and to conform to the outline of its container, i.e., a liquid, a gas, a viscoelastic fluid, etc. Typically, fluids are materials that are unable to withstand a static shear stress, and when a shear stress is applied, the fluid experiences a continuing and permanent distortion. The fluid may have any suitable viscosity that permits flow. If two or more fluids are present, each fluid may be independently selected among essentially any fluids (liquids, gases, and the like) by those of ordinary skill in the art, by considering the relationship between the fluids. In some cases, the droplets may be contained within a carrier fluid, e.g., a liquid.

In some embodiments, the carbon particles are incorporated in the matrix of the colloidal particles.

In some embodiments, the inorganic nano-particles are selected from the group consisting of polymer particles, metallic particles, semi-conducting particles, emulsion drops, inorganic particles, and any combination thereof.

In some embodiments, the inorganic particles are selected from the group consisting of silica, titanium oxide, clay, and any combination thereof.

In some embodiments, the carbon particles comprise carbon nanotubes.

In some embodiments, the first dispersion and the second dispersion form an oil on water mixture. In some embodiments, the first dispersion corresponds to the aqueous phase. In some embodiments, the second dispersion corresponds to the oil phase.

In some embodiments, the first dispersion comprises an aqueous dispersion. In some embodiments, the first dispersion comprises water. In some embodiments, the aqueous phase comprises water, phosphate buffer, acetate buffer, citrate buffer, or Tris buffer, any combination thereof.

In some embodiments, the second dispersion comprises a solvent insoluble in water. In some embodiments, the second dispersion comprises a non-polar organic solvent. In some embodiments, the second dispersion comprises toluene, heptane, cyclohexane, benzene, xylene, mesitylene, chlorobenzene, pentane, hexane, or any combination thereof. In some embodiments, the oil phase comprises a water immiscible or sparingly water-soluble solvent. The solvent is preferably a silicone oil, aliphatic esters, aromatic hydrocarbons, C6˜16 chain length of alkanes and alcohols, petroleum hydrocarbons, fatty esters, or any combination thereof.

In some embodiments, the two or more stabilizing precursor molecules with opposite polarity comprise organosilanes. In some embodiments, the organosilanes comprise 3-Aminopropyltriethoxysilane (APTES) and dodecyltriethoxysilane (DTES).

In some embodiments, the organosilanes are reactive towards hydrolysis. In some embodiments, the organosilanes are reactive towards condensation.

In some embodiments, the two or more stabilizing precursor molecules with opposite polarity are used in a ratio of 0.6:1 to 1:1, 0.7:1 to 1:1, 0.8:1 to 1:1, or 0.9:1 to 1:1, including any range therebetween.

In some embodiments, the particles comprises hydrophilic functional groups. In some embodiments, the inorganic particles comprise hydrophilic functional groups. In some embodiments, the hydrophilic functional groups are OH-groups.

In some embodiments, the w/w concentration of the inorganic nano-particles within the Pickering emulsion is in the range of 0.2 wt % to 10 wt %, 0.3 wt % to 10 wt %, 0.4 wt % to 10 wt %, 0.5 wt % to 10 wt %, 1 wt % to 10 wt %, 1.5 wt % to 10 wt %, 2 wt % to 10 wt %, 0.2 wt % to 9 wt %, 0.2 wt % to 8 wt %, 0.2 wt % to 7 wt %, 0.2 wt % to 6 wt %, 0.2 wt % to 5 wt %, 1 wt % to 8 wt %, 1 wt % to 7 wt %, 1 wt % to 6 wt %, 1 wt % to 5 wt %, 2 wt % to 8 wt %, 2 wt % to 7 wt %, 2 wt % to 6 wt %, or 2 wt % to 5 wt %, including any range therebetween.

In some embodiments, the w/w concentration of the inorganic nano-particles within the first

In some embodiments, the w/w concentration of the carbon particles (e.g. MWCNT) within the Pickering emulsion is between 0.05 and 20%, between 0.05 and 0.1%, between 0.1 and 0.5%, between 0.5 and 1%, between 1 and 3%, between 3 and 5%, between 5 and 7%, between 7 and 10%, between 10 and 15%, between 15 and 20%, including any range therebetween.

In some embodiments, the first dispersion/second dispersion ratio is in the range of 40:50 to 98:2, 45:50 to 98:2, 50:50 to 98:2, 60:50 to 98:2, 45:50 to 98:2, 70:50 to 98:2, 80:50 to 98:2, 85:50 to 98:2, 90:50 to 98:2, 40:50 to 95:5, 40:50 to 90:10, 40:50 to 85:15, 40:50 to 80:20, 40:50 to 70:30, 40:50 to 60:40, 45:50 to 95:5, 45:50 to 90:10, 45:50 to 85:15, 45:50 to 80:20, 45:50 to 70:30, 40:50 to 60:40, 50:50 to 95:5, 50:50 to 90:10, 50:50 to 85:15, 50:50 to 80:20, 50:50 to 70:30, or 50:50 to 60:40, including any range therebetween.

In some embodiments, the suitable conditions comprise ultrasonication. In some embodiments, the suitable conditions are conditions suitable for polymerizing a plurality of precursors (hydrophobic and hydrophilic precursors).

In some embodiments, the ultrasonication is performed between 30 seconds and 30 minutes, 30 seconds and 25 minutes, 30 seconds and 20 minutes, 30 seconds and 15 minutes, 30 seconds and 10 minutes, 1 minute and 30 minutes, 2 minutes and 30 minutes, 5 minutes and 30 minutes, 10 minutes and 30 minutes, 1 minute and 20 minutes, 2 minutes and 20 minutes, 5 minutes and 20 minutes, 10 minutes and 20 minutes, 1 minute and 15 minutes, 2 minutes and 15 minutes, 5 minutes and 15 minutes, 10 minutes and 15 minutes, 1 minute and 10 minutes, 2 minutes and 10 minutes, or 5 minutes and 10 minutes, including any range therebetween.

In some embodiments, the colloidosomes have a diameter size in the range of 1 μm to 300 μm, 1 μm to 280 μm, 1 μm to 250 μm, 1 μm to 200 μm, 1 μm to 180 μm, 1 μm to 150 μm, 2 μm to 300 μm, 5 μm to 300 μm, 10 μm to 300 μm, 15 μm to 300 μm, 20 μm to 300 μm, 2 μm to 250 μm, 2 μm to 200 μm, 2 μm to 180 μm, 2 μm to 150 μm, 5 μm to 250 μm, 5 μm to 200 μm, 5 μm to 180 μm, 5 μm to 150 μm, 10 μm to 250 μm, 10 μm to 200 μm, 10 μm to 180 μm, or 10 μm to 150 μm, including any range therebetween.

In some embodiments, the core of the colloidosomes is void.

In some embodiments, the core of the colloidosomes comprises an oil, a polymer, a chemical compound, a liquid, or any combination thereof. In some embodiments, the core of the colloidosomes encapsulates the aqueous solvent (e.g. water, organic salt solution, inorganic slat solution, a buffer solution or a mixture thereof), and/or the water immiscible solvent.

### Definitions

As used herein, the term “alkyl” describes an aliphatic hydrocarbon including straight chain and branched chain groups. Preferably, the alkyl group has 21 to 100 carbon atoms, and more preferably 21-50 carbon atoms. Whenever a numerical range; e.g., “21-100”, is stated herein, it implies that the group, in this case the alkyl group, may contain 21 carbon atom, 22 carbon atoms, 23 carbon atoms, etc., up to and including 100 carbon atoms. In the context of the present invention, a “long alkyl” is an alkyl having at least 20 carbon atoms in its main chain (the longest path of continuous covalently attached atoms). A short alkyl therefore has 20 or less main-chain carbons. The alkyl can be substituted or unsubstituted, as defined herein.

The term “alkyl”, as used herein, also encompasses saturated or unsaturated hydrocarbon, hence this term further encompasses alkenyl and alkynyl.

The term “alkenyl” describes an unsaturated alkyl, as defined herein, having at least two carbon atoms and at least one carbon-carbon double bond. The alkenyl may be substituted or unsubstituted by one or more substituents, as described hereinabove.

The term “alkynyl”, as defined herein, is an unsaturated alkyl having at least two carbon atoms and at least one carbon-carbon triple bond. The alkynyl may be substituted or unsubstituted by one or more substituents, as described hereinabove.

The term “cycloalkyl” describes an all-carbon monocyclic or fused ring (i.e. rings which share an adjacent pair of carbon atoms) group where one or more of the rings does not have a completely conjugated pi-electron system. The cycloalkyl group may be substituted or unsubstituted, as indicated herein.

The term “aryl” describes an all-carbon monocyclic or fused-ring polycyclic (i.e. rings which share adjacent pairs of carbon atoms) groups having a completely conjugated pi-electron system. The aryl group may be substituted or unsubstituted, as indicated herein.

The term “alkoxy” describes both an O-alkyl and an —O-cycloalkyl group, as defined herein.

The term “aryloxy” describes an —O-aryl, as defined herein.

Each of the alkyl, cycloalkyl and aryl groups in the general formulas herein may be substituted by one or more substituents, whereby each substituent group can independently be, for example, halide, alkyl, alkoxy, cycloalkyl, nitro, amino, hydroxyl, thiol, thioalkoxy, carboxy, amide, aryl and aryloxy, depending on the substituted group and its position in the molecule. Additional substituents are also contemplated.

The term “halide”, “halogen” or “halo” describes fluorine, chlorine, bromine or iodine.

The term “haloalkyl” describes an alkyl group as defined herein, further substituted by one or more halide(s).

The term “haloalkoxy” describes an alkoxy group as defined herein, further substituted by one or more halide(s).

The term “hydroxyl” or “hydroxy” describes a —OH group.

The term “mercapto” or “thiol” describes a —SH group.

The term “thioalkoxy” describes both an —S-alkyl group, and a —S-cycloalkyl group, as defined herein.

The term “thioaryloxy” describes both an —S-aryl and a —S-heteroaryl group, as defined herein.

The term “amino” describes a —NR′R″ group, with R′ and R″ as described herein.

The term “heterocyclyl” describes a monocyclic or fused ring group having in the ring(s) one or more atoms such as nitrogen, oxygen and sulfur. The rings may also have one or more double bonds. However, the rings do not have a completely conjugated pi-electron system. Representative examples are piperidine, piperazine, tetrahydrofuran, tetrahydropyran, morpholino and the like.

The term “carboxy” or “carboxylate” describes a —C(O)OR′ group, where R′ is hydrogen, alkyl, cycloalkyl, alkenyl, aryl, heteroaryl (bonded through a ring carbon) or heterocyclyl (bonded through a ring carbon) as defined herein.

The term “carbonyl” describes a —C(O)R′ group, where R′ is as defined hereinabove.

The above-terms also encompass thio-derivatives thereof (thiocarboxy and thiocarbonyl).

The term “thiocarbonyl” describes a —C(S)R′ group, where R′ is as defined hereinabove.

A “thiocarboxy” group describes a —C(S)OR′ group, where R′ is as defined herein.

A “sulfinyl” group describes an —S(O)R′ group, where R′ is as defined herein.

A “sulfonyl” or “sulfonate” group describes an —S(O)2R′ group, where R′ is as defined herein.

A “carbamyl” or “carbamate” group describes an —OC(O)NR′R″ group, where R′ is as defined herein and R″ is as defined for R′.

A “nitro” group refers to a —NO2 group.

The term “amide” as used herein encompasses C-amide and N-amide.

The term “C-amide” describes a —C(O)NR′R″ end group or a —C(O)NR′-linking group, as these phrases are defined hereinabove, where R′ and R″ are as defined herein.

The term “N-amide” describes a —NR″C(O)R′ end group or a —NR′C(O)— linking group, as these phrases are defined hereinabove, where R′ and R″ are as defined herein.

The term “carboxylic acid derivative” as used herein encompasses carboxy, amide, carbonyl, anhydride, carbonate ester, and carbamate.

A “cyano” or “nitrile” group refers to a —CN group.

The term “azo” or “diazo” describes an —N═NR′ end group or an —N═N— linking group, as these phrases are defined hereinabove, with R′ as defined hereinabove.

The term “guanidine” describes a —R′NC(N)NR″R′″ end group or a —R′NC(N) NR″-linking group, as these phrases are defined hereinabove, where R′, R″ and R″ are as defined herein.

As used herein, the term “azide” refers to a —N3 group.

The term “sulfonamide” refers to a —S(O)2NR′R″ group, with R′ and R″ as defined herein.

The term “phosphonyl” or “phosphonate” describes an —OP(O)—(OR′)2 group, with R′ as defined hereinabove.

The term “phosphinyl” describes a —PR′R″ group, with R′ and R″ as defined hereinabove.

The term “alkylaryl” describes an alkyl, as defined herein, which substituted by an aryl, as described herein. An exemplary alkylaryl is benzyl.

The term “heteroaryl” describes a monocyclic or fused ring (i.e. rings which share an adjacent pair of atoms) group having in the ring(s) one or more atoms, such as, for example, nitrogen, oxygen and sulfur and, in addition, having a completely conjugated pi-electron system. Examples, without limitation, of heteroaryl groups include pyrrole, furan, thiophene, imidazole, oxazole, thiazole, pyrazole, pyridine, pyrimidine, quinoline, isoquinoline and purine. The heteroaryl group may be substituted or unsubstituted by one or more substituents, as described hereinabove. Representative examples are thiadiazol, pyridine, pyrrole, oxazole, indole, purine and the like.

As used herein, the terms “halo” and “halide”, which are referred to herein interchangeably, describe an atom of a halogen, that is fluorine, chlorine, bromine or iodine, also referred to herein as fluoride, chloride, bromide and iodide.

The term “haloalkyl” describes an alkyl group as defined above, further substituted by one or more halide(s).

### General

As used herein the term “about” refers to ±10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

As used herein, the term “treating” includes abrogating, substantially inhibiting, slowing or reversing the progression of a condition, substantially ameliorating clinical or aesthetical symptoms of a condition or substantially preventing the appearance of clinical or aesthetical symptoms of a condition.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non-limiting fashion.

### Materials and Methods

### Chemicals and Buffers

MWCNTs (NC7000™, 95% purity) and carboxylated MWCNTs (>8% carboxy functionalized) were obtained from Nanocyl SA (Sambreville, Belgium). Both have an average diameter of ˜10 nm and an average length of 1.5 Hydrophilic fumed silica (AEROSIL® 300, 300 m²/g BET area, primary particle diameter ˜7 nm, as provided by the manufacturer) was purchased from Evonik (Essen, Germany). (3-Aminopropyl)triethoxysilane (APTES, 99%), dodecyltriethoxysilane (DTES, technical grade), Nile Red (technical grade), 6-aminofluorescein (BioReagent), N-(3-dimethylaminopropyl)-N′-ethylcarbodiimide hydrochloride (EDC, BioXTra), and 2-(4-morpholino)ethanesulfonic acid hydrate (IVIES, ≥99.5%) and sodium dodecyl sulfate (SDS, BioReagent, ≥98.5%) were from Sigma-Aldrich (Steinheim, Germany). All chemicals were used without further purification. Toluene (analytical reagent grade) and water (Optima® LC/MS) were provided by Fisher Scientific Ltd. (Loughborough, UK).

### Preparation of Silica Dispersions

Prior to emulsification, the as-received fumed silica nanoparticles (SiNPs) were suspended in ultrapure water by an high-intensity ultrasonic processor (Vibra-Cell™ VCX 750, Sonics, USA) to give dispersions of 0.5, 1, 2, and 5 wt.-%. Sonication was done for 10 min using a 13 mm diameter probe tip, operating at 20 kHz with 750 W power and 35% amplitude. During sonication the vessel was cooled in an ice bath. The resulting dispersions were colorless or bluish in appearance. In all sonication processes described henceforth the same operating conditions were employed.

### Pickering Emulsions by In Situ Functionalization of Silica

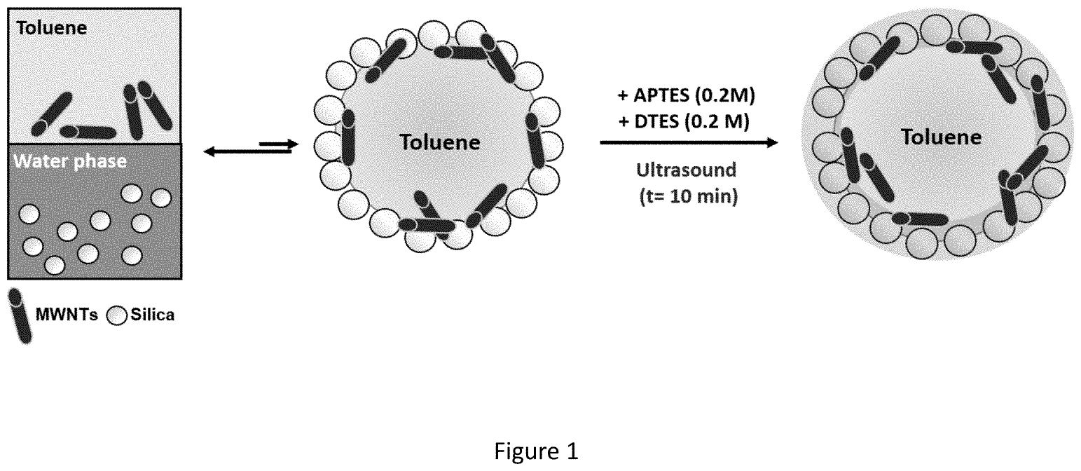

Emulsions were prepared by first dissolving MWCNTs in a specific volume of toluene (1-5 mL). To these suspensions, 5-9 mL of the silica dispersions were added. The total volume of the as-generated biphasic systems was in all cases 10 mL. In this way, emulsions with different o/w ratios and varying amounts of MWCNTs (1-5 mg) and SiNPs (0.5-5 wt.-%) have been prepared (Table 1). 500 μL of APTES and of DTES (both 0.2 M) were added to the biphasic mixtures and the systems were then emulsified using the same operating conditions as described above (FIG. 1). The emulsions were then stored under ambient conditions until further analysis.

TABLE 1
Composition of the individual MWCNT/silica toluene-in-water emulsions
used in this study. Samples were prepared for four different
silica contents, and three different MWCNT concentrations. The
oil volume in the mixtures ranged from 10-50 vol.-%.

o/w ratio

| | wt.-SiO₂ [%] | 10/90 | 20/80 | 30/70 | 50/50 |
|---|---|---|---|---|---|
| 1 mg | 0.5 | ✓ | ✓ | ✓ | ✓ |
| MWCNT | 1 | ✓ | ✓ | ✓ | ✓ |
| | 2 | ✓ | ✓ | ✓ | ✓ |
| | 5 | ✓ | ✓ | ✓ | ✓ |
| 2 mg | 0.5 | ✓ | ✓ | ✓ | ✓ |
| MWCNT | 1 | ✓ | ✓ | ✓ | ✓ |
| | 2 | ✓ | ✓ | ✓ | ✓ |
| | 5 | X | X | X | X |
| 5 mg | 0.5 | ✓ | ✓ | ✓ | ✓ |
| MWCNT | 1 | ✓ | ✓ | ✓ | ✓ |
| | 2 | ✓ | ✓ | ✓ | ✓ |
| | 5 | X | X | X | X |

### Preparation of Control Samples

Various control samples were prepared in order to determine the individual influence of each reactant on the oil droplet formation. To this end, the composition of each sample was varied, either including all components or leaving some of them out. All formulations were made of a 50:50 mixture of toluene and water (v/v). If not otherwise stated, the continuous aqueous phase consisted of 1 wt.-% of SiNPs. The amount of MWCNTs (untreated and oxidized), if added, was 1 mg; in case of APTES and DTES, 500 μL of a 0.2 M stock solution were added. All mixtures were processed under identical conditions, as described above. The exact composition of each formulation is listed in Table 2.

TABLE 2
Composition of the control samples. The amount of the particles, when
added to the mixtures, was kept constant in all experiments, and
consisted of 1 mg CNTs and/or 1 wt.-% silica, respectively. All samples
were emulsified for 10 minutes and immediately analysed.

| Emulsion Nr. | Particle 1 | Particle 2 | Silane 1 | Silane 2 |
|---|---|---|---|---|
| 1 | SiO₂ | MWCNT | APTES | DTES |
| 2 | SiO₂ | MWCNT | APTES | |
| 3 | SiO₂ | MWCNT | | DTES |
| 4 | SiO₂ | MWCNT | | |
| 5 | SiO₂ | MWCNT-COOH | APTES | DTES |
| 6 | SiO₂ | MWCNT-COOH | APTES | |
| 7 | SiO₂ | MWCNT-COOH | | DTES |
| 8 | SiO₂ | MWCNT-COOH | | |
| 9 | SiO₂ | | APTES | DTES |
| 10 | SiO₂ | | APTES | |
| 11 | SiO₂ | | | DTES |
| 12 | SiO₂ | | | |
| 13 | | MWCNT | APTES | DTES |
| 14 | | MWCNT | APTES | |
| 15 | | MWCNT | | DTES |
| 16 | | MWCNT | | |
| 17 | | MWCNT-COOH | APTES | DTES |
| 18 | | MWCNT-COOH | APTES | |
| 19 | | MWCNT-COOH | | DTES |
| 20 | | MWCNT-COOH | | |
| 21 | | | APTES | DTES |

### Emulsion Stability Expressed by the Creaming Index

The relative stability of the o/w emulsions was evaluated by determining the percentage of gravitational separation according to McClements. To this end, the emulsions samples were gently agitated immediately after sonication to make sure they were initially homogeneous and then allowed to settle via gravitation/buoyancy. After a certain period (0.5, 24 h) the height of any distinct boundaries formed between different layers was then measured with a ruler. The extent of creaming can then be expressed by the so-called creaming index CI (%, Eq. 1) that is calculated as follows:

CI=(H_{S}/H_{E})×100, (Eq. 1)

where HS=total height of the transparent serum layer (here: water) at the bottom of the vials and H_{E}=total height of emulsion layer. An increase in the CI provides indirect information about the emulsion instability.

### Bright Field Optical Microscopy

Image acquisition was done in bright field modus using an Olympus IX81 inverted microscope, equipped with a solid state laser with a 488 nm excitation laser line, and HC PL APO CS 20×/0.75 objective (with Leica Application Suite X software (LASX), Leica, Wetzlar, Germany). 1 mL of each emulsion was placed on a microscope slide and sealed with a cover slide in order to prevent evaporation of the solvents. Droplet size was analyzed using Fiji software by measuring the droplet diameters from confocal microscopy images for each emulsion type.

### Fluorescence Labelling of MWCNT Surface Functional Groups

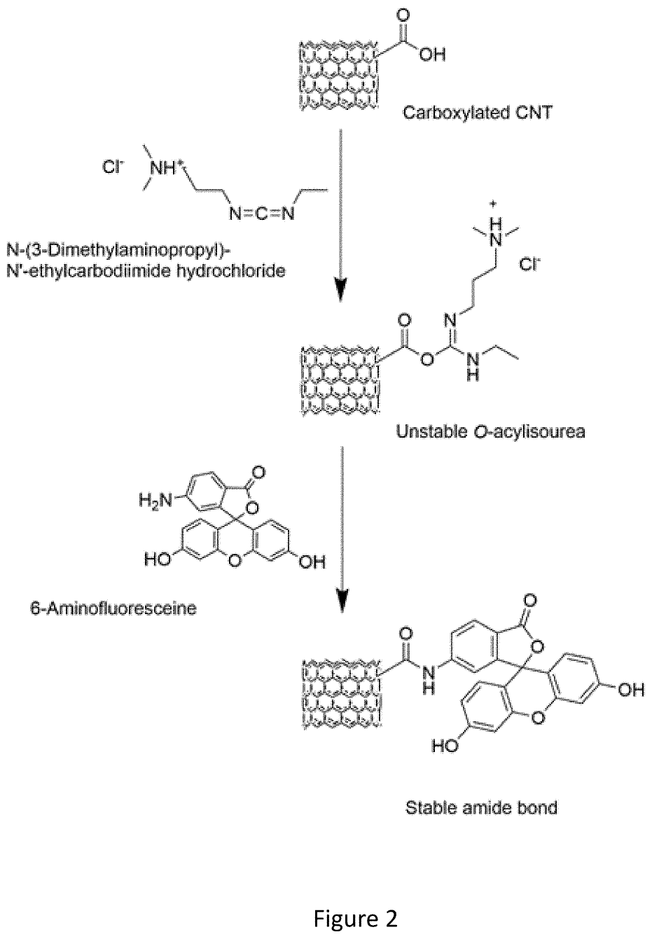

Carboxyl functionalized MWCNTs were conjugated to 6-aminofluorescein (6-AF) via amidation reaction using N-(3-Dimethylaminopropyl)-N′-ethylcarbodiimide hydrochloride (EDC) as a zero-length cross-linker (FIG. 2).

To this end, 50 mg of the MWCNTs were dispersed in 10 mL of a 0.2 M SDS-solution and sonicated for two minutes at a 25% amplitude. 10 mL of the MWCNT dispersion were then mixed with 30 mL EDC buffer solution (7 mM), 10 mL of buffered 6-AF solution (3 mM) and 60 mL of MES buffer (0.5 M). The reactants were vortexed for one hour under ambient conditions in dark environment. Solid products were recovered after precipitation in methanol and subsequent filtration. The obtained nanotubes were rinsed with methanol to remove unreacted excess dye in the solution and physisorbed 6-AF molecules. This was monitored by analyzing the remaining fluorescence of the supernatant (λ_{exc/em}=488/520 nm) after centrifugation (20379×g for 20 min, Sigma 3-18KS centrifuge from Sigma Laborzentrifugen GmbH, Germany) in a microplate reader (Synergy™ Neo2 with Gen5 2.0 Data Analysis Software, BioTek Instruments, Inc., Winooski, Vt., USA). The fluorescent MWCNTs were then dried overnight at 35° C. in a vacuum oven (Sheldon Manufacturing, Inc., OR, USA) and eventually used for the preparation of the emulsions. Prior to emulsification, 1 mL of Nile Red (0.03 mM, Toluene) was added to stain the oil phase. Its distribution in the emulsion as well as the localization of the fluorescent MWCNTs was followed by confocal laser scanning microscopy analysis.

### Confocal Laser Scanning Microscopy (CLSM)

Confocal images were collected on a Leica SP8 confocal microscope (Leica Microsystems CMS GmbH, Wetzlar/Germany) equipped with an inverted microscope fitted with a 40×HC PL APO CS2 (1.10 NA) water immersion objective. Excitation of 6-AF and Nile Red was from the 488 nm and the 552 nm laser line of an OPS laser, respectively. The 1024×1024 images were collected using Leica Application Suite X software (Leica Microsystems CMS GmbH, Wetzlar/Germany).

### High-Resolution Scanning Electron Microscopy (HR SEM)

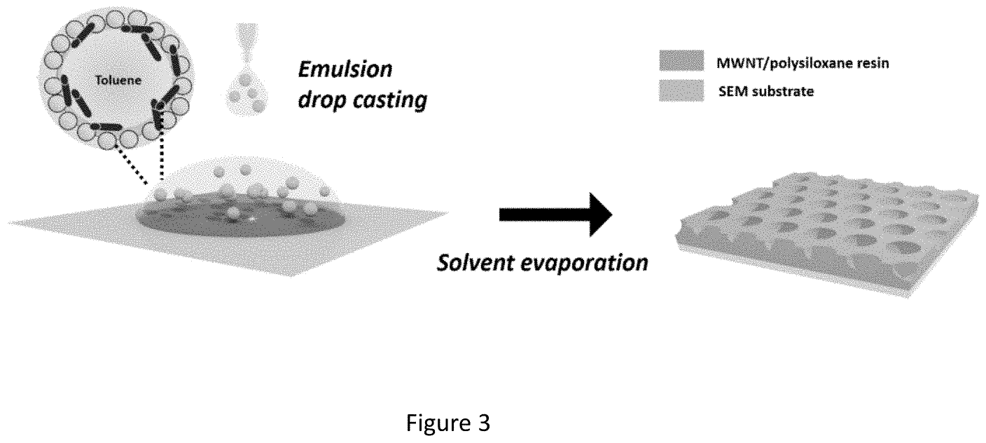

Measurements were performed using a MIRA3 field-emission SEM microscope (Tescan, Brno/Czech Republic) with an acceleration voltage of 7.0 kV and a secondary electron (SE) detector. Liquid samples were drop-casted on a conductive double stick carbon tape and dried at ambient conditions (FIG. 3). Prior to imaging, a thin layer of iridium was evaporated onto the samples to render them electrically conductive, and avoiding surface charging by the electron beam.

### Cryogenic-Field Emission Scanning Electron Microscopy

Cryogenic-field emission scanning electron microscopy (cryo-FESEM) analysis was performed on a JSM-7800F Schottky Field Emission Scanning Electron Microscope (Jeol Ltd., Tokyo/Japan). Liquid nitrogen was used in all heat exchange units of the cryogenic system (Quorum PP3010, Quorum Technologies Ltd., Laughton/United Kingdom). A small droplet of the freshly mixed emulsions was placed on the sample holder between two rivets, quickly frozen in liquid nitrogen for a few seconds and transferred to the preparation chamber where it was fractured (at −140° C.). The revealed fractured surface was sublimed at −90° C. for 10 min to eliminate any presence of condensed ice and then coated with platinum. The temperature of the sample was kept constant at −140° C. Images were acquired with either a secondary electrons (SE), low electron detector (LED) or backscattered electron (BSE) detector at an accelerating voltage of 1 to 15 kV and a working distance of max. 10.1 mm.

### Example 1

### MWCNT/Silica Pickering Emulsions by In Situ Functionalization of Silica

In total, 48 samples were prepared, subdivided in 3×(4×4) groups (Table 1). Two types of experiments were carried out: First, the silica concentration was varied between 0.5 to 5 wt.-% while keeping the oil volume fraction constant. Second, the oil content was varied from 10-50 vol.-% at constant silica concentrations. These experiments were done for three different MWCNT concentrations, ranging from 1 to 5 mg.

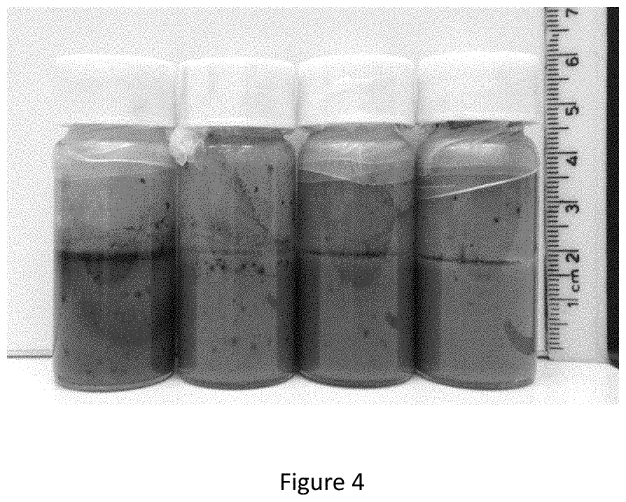

The generated emulsions were milky-grey to dark black, depending on the amount of MWCNTs used in the experiment. In some samples, the occurrence of black colored dots indicated the presence of agglomerated, not well dispersed MWCNTs. FIG. 4 shows an example of a series of emulsions immediately after emulsification, prepared with 1 mg MWCNT in the toluene phase and 2 wt.-% silica in the aqueous phase, and oil volume fractions ranging from 10 to 50 vol.-%.

In all of the cases, oil-in-water (o/w) emulsions were obtained. Typically, the full oil was dispersed, independent of the o/w ratio or the amount of MWCNTs in the mixture. Only for samples with at 0.5 wt.-% silica content, the system was not completely emulsified. Here, the emulsion phase volume increased from 10 to 20 vol.-% oil fraction, but thereafter remained constant with respect to the overall oil content.

Success or failure of the emulsification depended mainly on the concentration of the silica used in the experiments. Samples with 5 wt.-% silica concentrations barely emulsified; only samples with a 1 mg MWCNT content revealed the generation of a small number of oil droplets under the microscope, within a thick silica water suspension. A reasonable analysis, however, was not possible due to the irregular shape and morphology of the very few emulsion droplets.

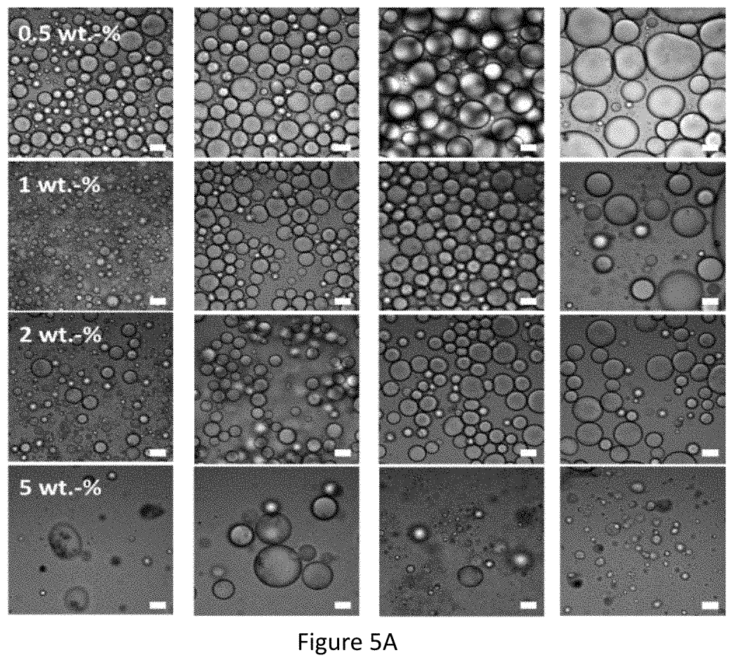

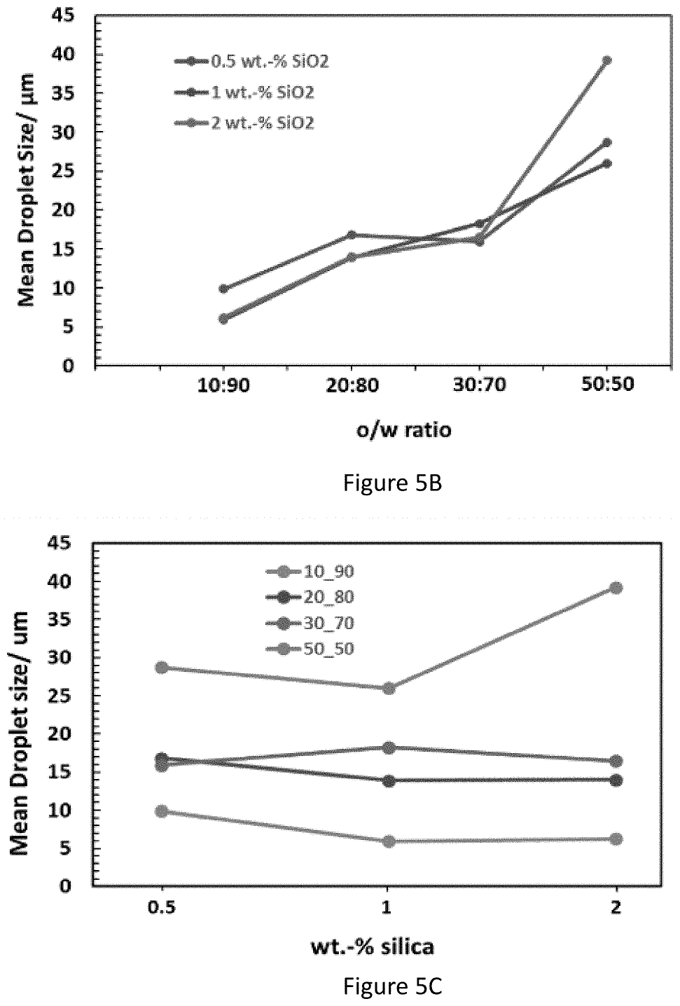

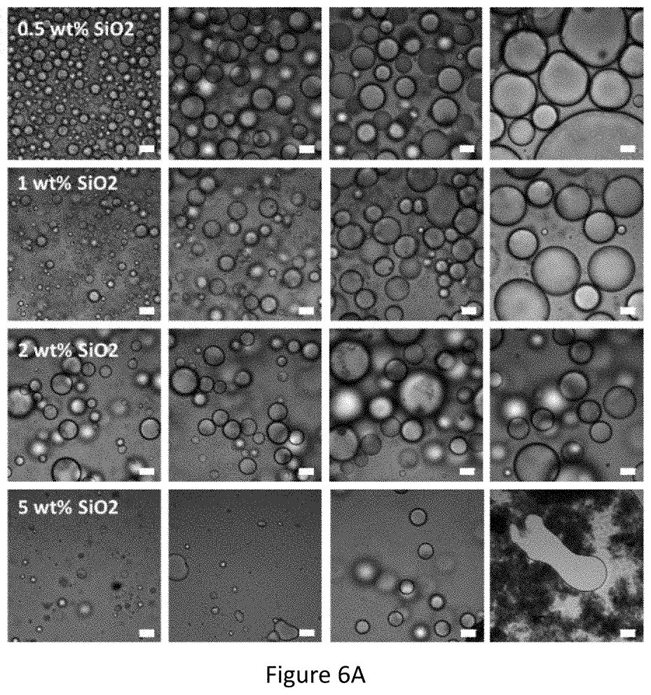

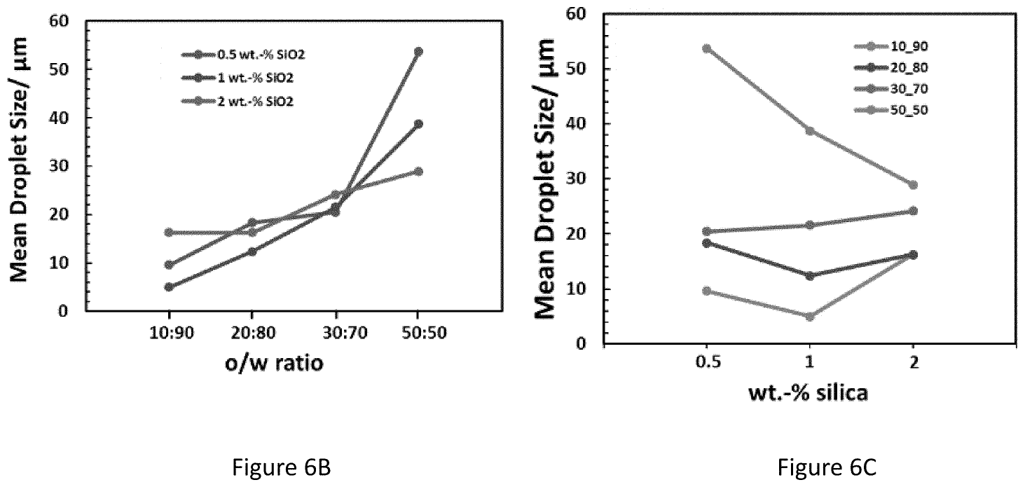

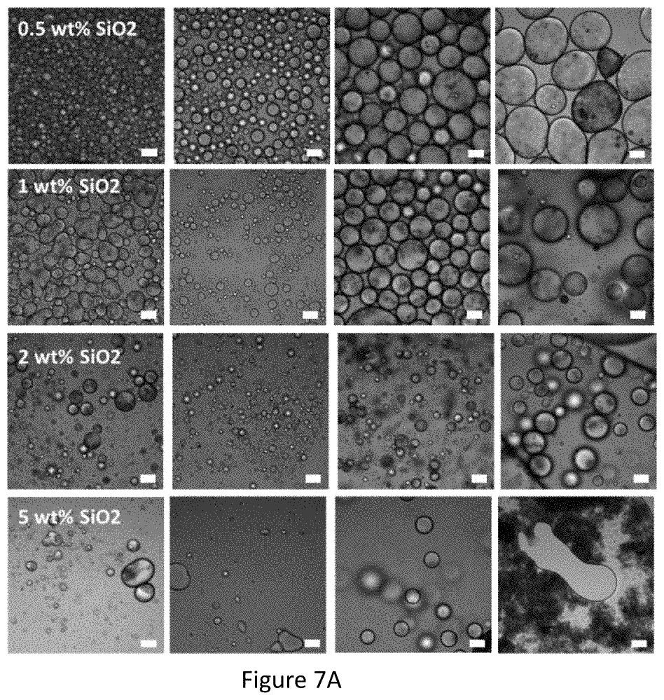

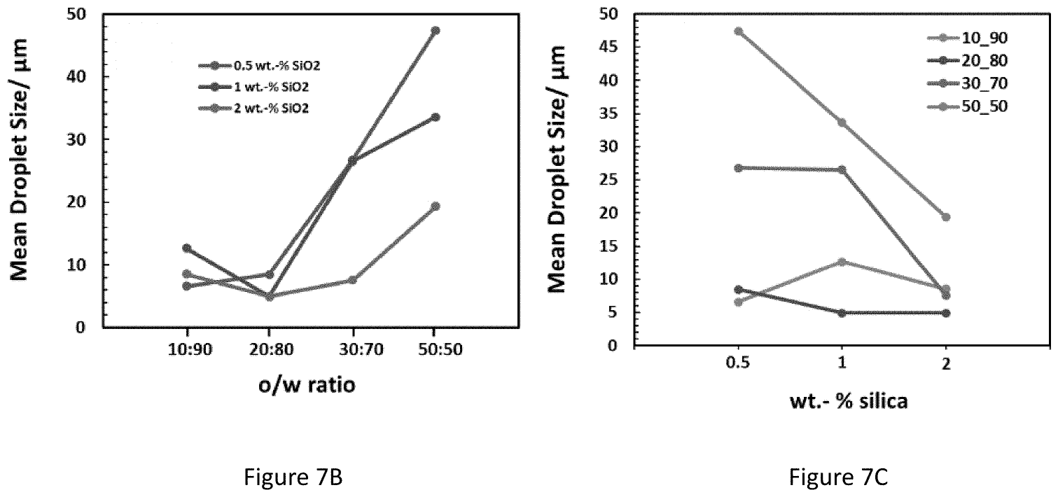

Other than expected, the silica content had not an explicit influence on the droplet size the experiments, while in general, a higher silica content should decrease the droplet diameter. FIG. 5 shows exemplarily the droplet size evaluation for the 1 mg MWCNT series as observed in optical microscopy. FIG. 5A shows, for example, 10 vol.-% oil ratio series, with the droplet size decreasing from 0.5 to 1 wt.-% silica content but then increased again for the 5 wt.-%. These features have been observed as well for the other series (FIGS. 6A-C and FIGS. 7A-C for 2 and 5 mg MWCNT experiments). However, the droplet size shows a clear dependence on the o/w ratio and increases for all series (exception: the 5 wt.-% silica series) with increasing oil volume percentage (FIG. 5B). Among the different silica contents, changes of the average droplet size at a given o/w ratio are generally small and became only significant at for the 50 vol.-% samples (FIG. 5C).

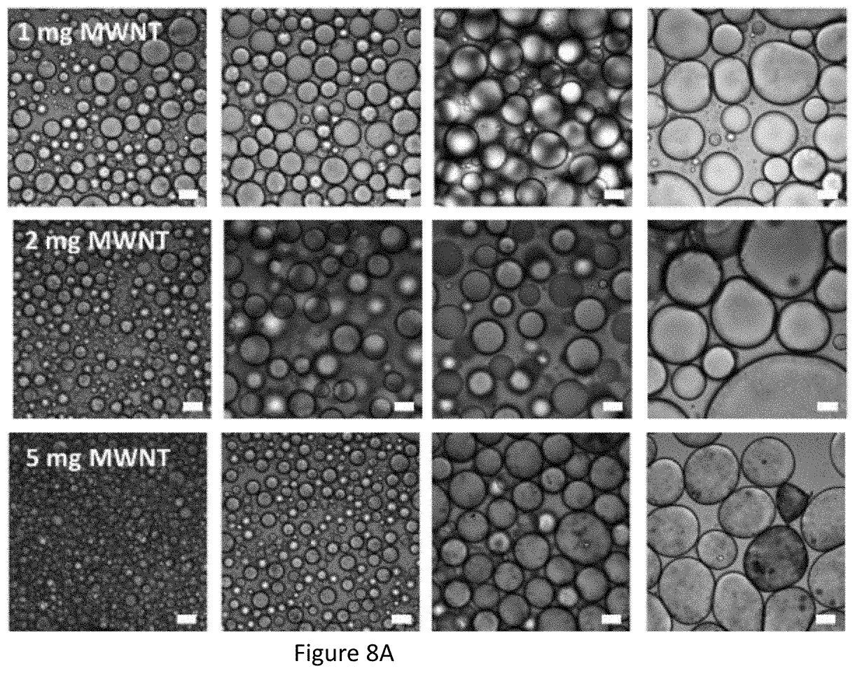

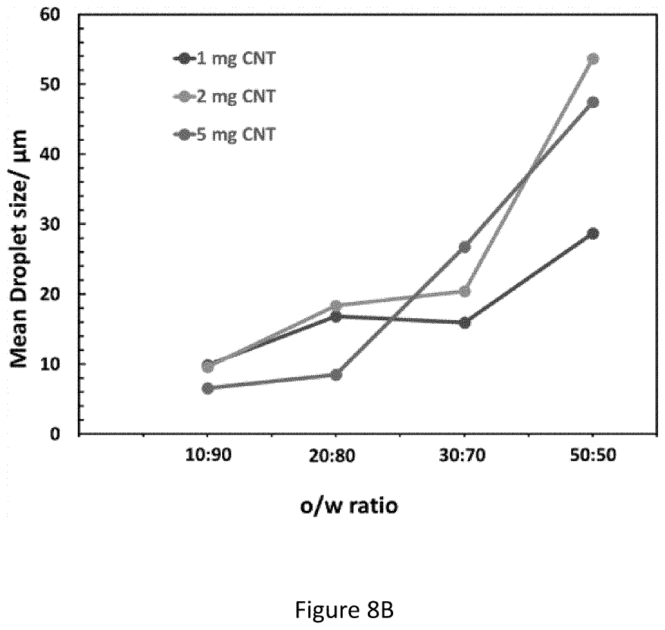

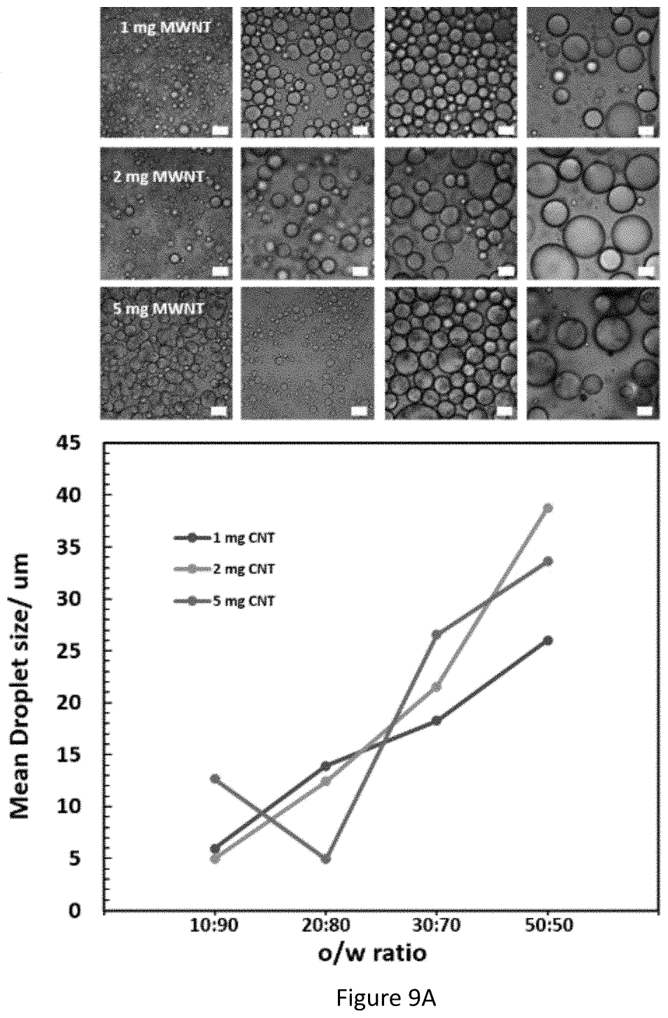

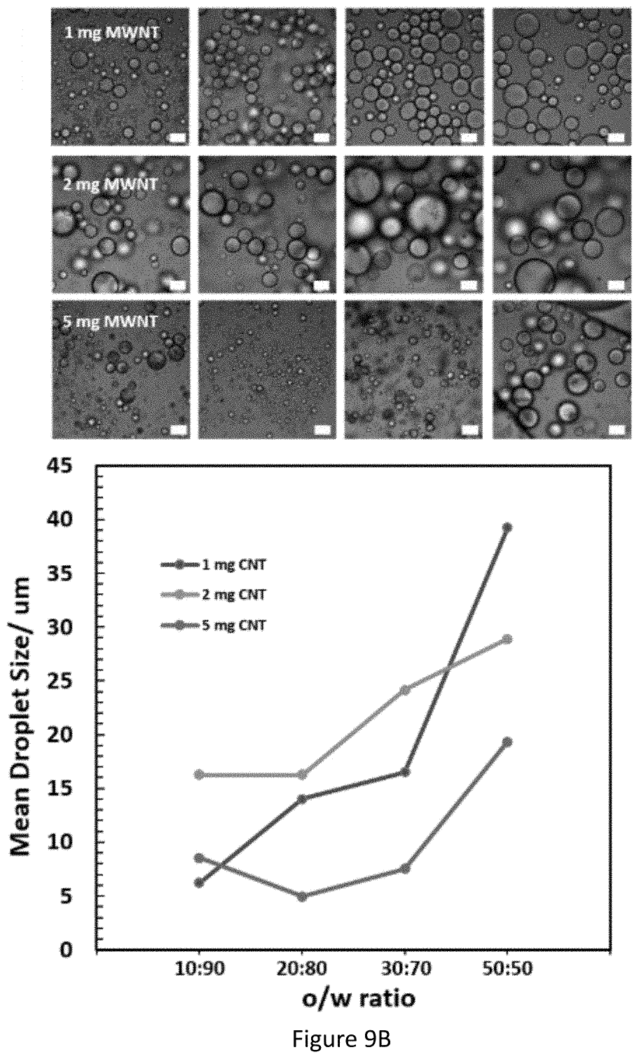

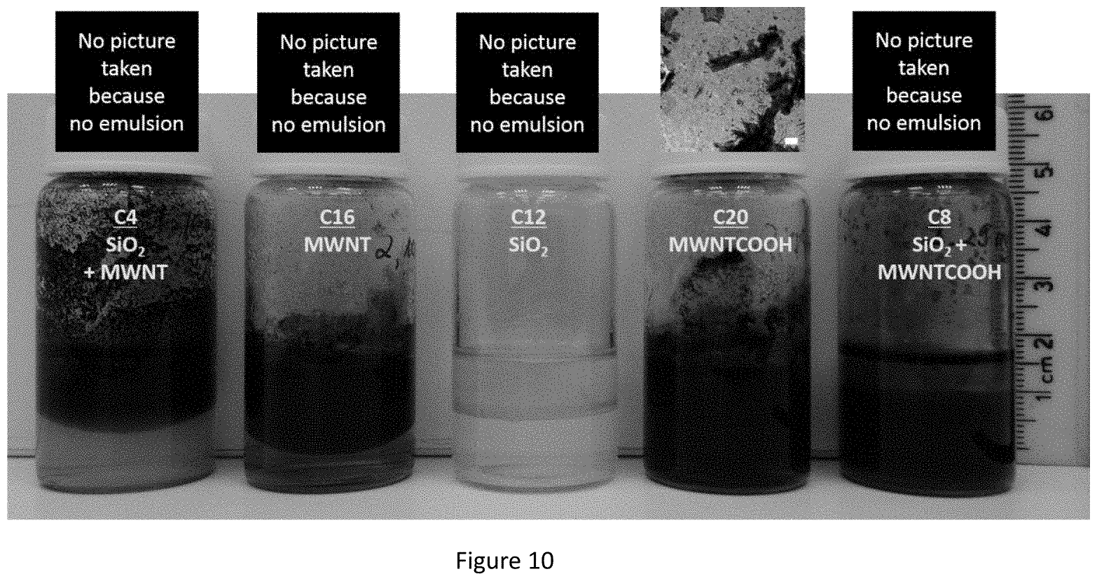

The amount of MWCNTs did not show a substantial influence on the droplet size, as exemplarily demonstrated for the 0.5 wt.-% silica series in FIGS. 6A-B. Figures for other silica contents can be found in the supplementary information (FIGS. 8A-B, FIGS. 9A-B and FIG. 10). We therefore deduce, that silica is the only stabilizing particle in the system, and that the MWCNTs are fixed at the droplet periphery without any substantial impact on the droplet stabilization process.

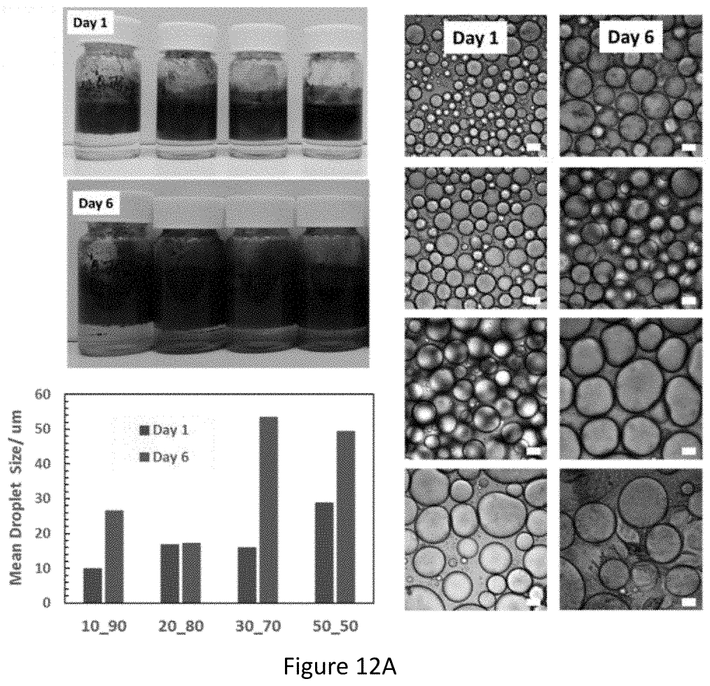

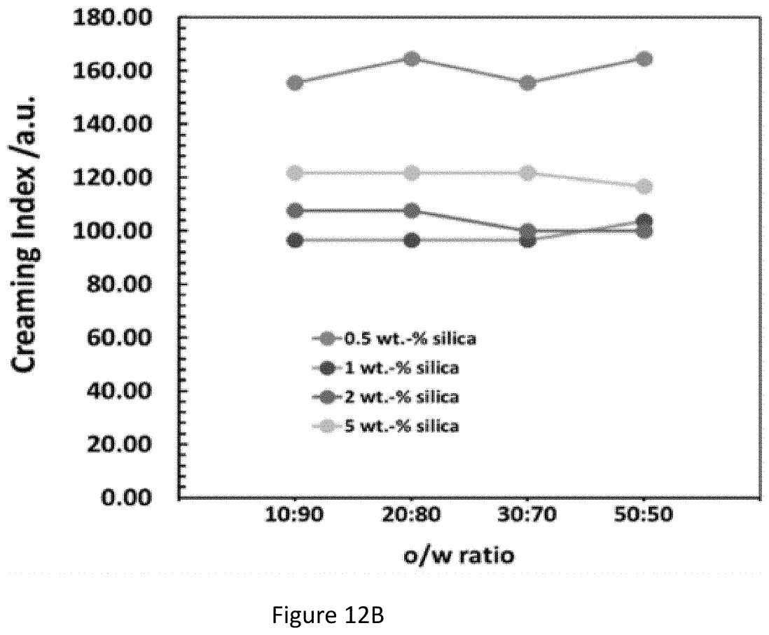

Samples with a 0.5 wt.-% silica content and 1 mg MWCNTs almost immediately formed a creamed layer after emulsification, coexisting with a clear supernatant aqueous phase at the bottom. Although no further creaming or phase separation occurred thereafter, coalescence could be clearly seen after one week of storage (FIGS. 12A-B). Samples with a silica content higher than 0.5 wt.-% creamed slowly over 24 h after preparation but remained stable thereafter (data not shown). The creaming index of freshly prepared MWCNT/silica emulsions as a function of the o/w ratio at an MWCNT content of 1 mg is exemplarily shown in FIG. 7b. The oil volume percentage did not show any substantial impact on the creaming behavior of any of the emulsions. As visually observed, the highest CI can be found for samples with 0.5 wt.-% silica.

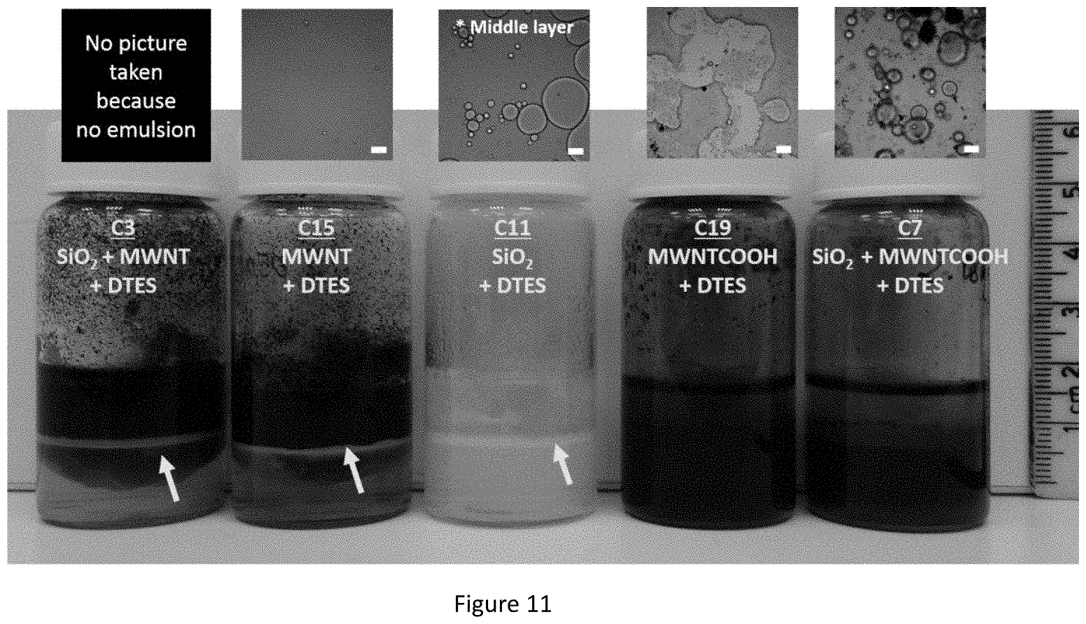

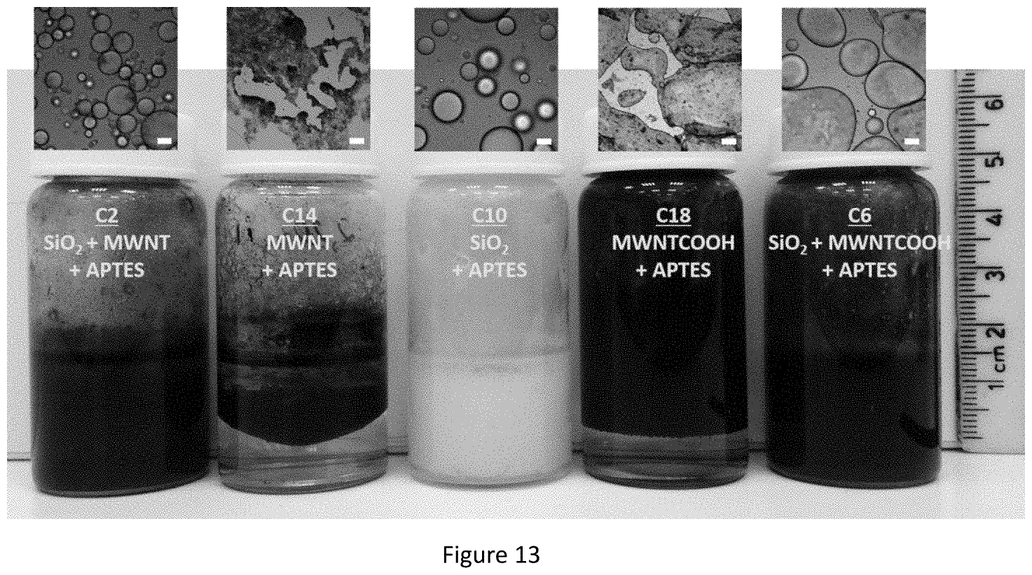

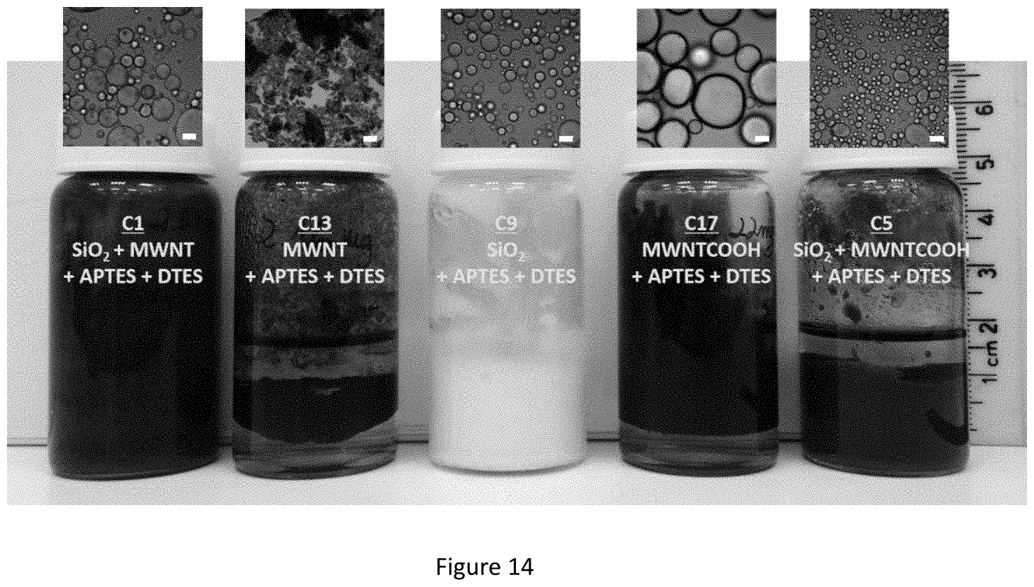

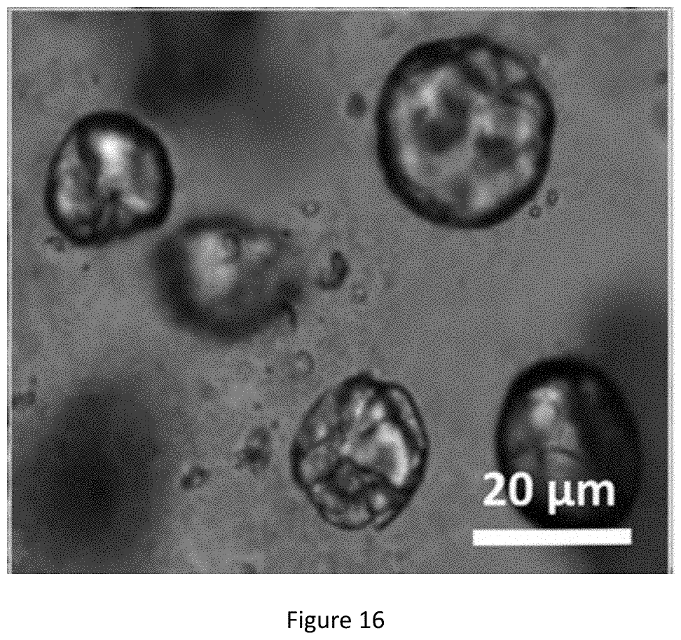

In order to identify the key components, responsible for the successful emulsification, we prepared different control samples in which the individual composition was varied (Table 2). To rule out any surfactant effect stemming from the silane monomers in use, we first investigated the emulsification potential of an APTES/DTES o/w mixture without any additional stabilizers. Immediate phase separation took place right after sonication. As well, emulsions that were prepared with silica NPs only, without any addition of silanes and MWCNTs, phase-separated immediately after sonication. Obviously, the particles were completely wetted by the water phase and preferred to remain in the bulk water rather than staying fixed at the interface. Likewise, MWCNT-only mixtures showed an improved dispersion of the MWCNTs in the oil phase after the sonication, but no emulsion formed (FIG. 11). The same behavior was observed when DTES was added to the mixtures. Although the functionalization of the SiNPs with DTES should turn the silica particles more hydrophobic, any attempts to stabilize the emulsions failed. Most likely, the steric hindrance imposed by the bulky n-dodecyl side chain drastically decreases hydrolysis and polycondensation rates. DIES is thus neither reacting to a measurable extent with silica, but is inert as well towards self-condensation (FIG. 13). When only APTES was added to the mixtures (FIG. 14) a stabile emulsion has been formed. While the MWCNT-only system still remained phase-separated, the silica NP mixtures easily reacted to homogeneous stable emulsions that showed similar microstructures than the original system, where both silanes were present in the mixture (FIG. 16).

We therefore concluded, that two prerequisites need to be fulfilled to successfully generate a Pickering emulsion and eventually a core-shell system: First, hydrophilic functional groups need to be present at the particle surfaces, such as the surface OH-groups at the silica surface. Without any reactive group at the particle surface, like in the case of the MWCNTs, emulsification for systems like the ones presented here, will fail. Second, the choice of the silane monomer is crucial; the silanes need to be reactive towards hydrolysis and condensation in order to immobilize adequate particles at the o/w interface. In case they are prone to self-condensation, the gel or oily oligomers that will be formed may further condense with Si—OH groups of the silica surface, resulting in a thick coating layer and eventually in a core-shell structure.

### Example 2

### Localization of MWCNTs at the o/w Interface as Revealed by CLSM

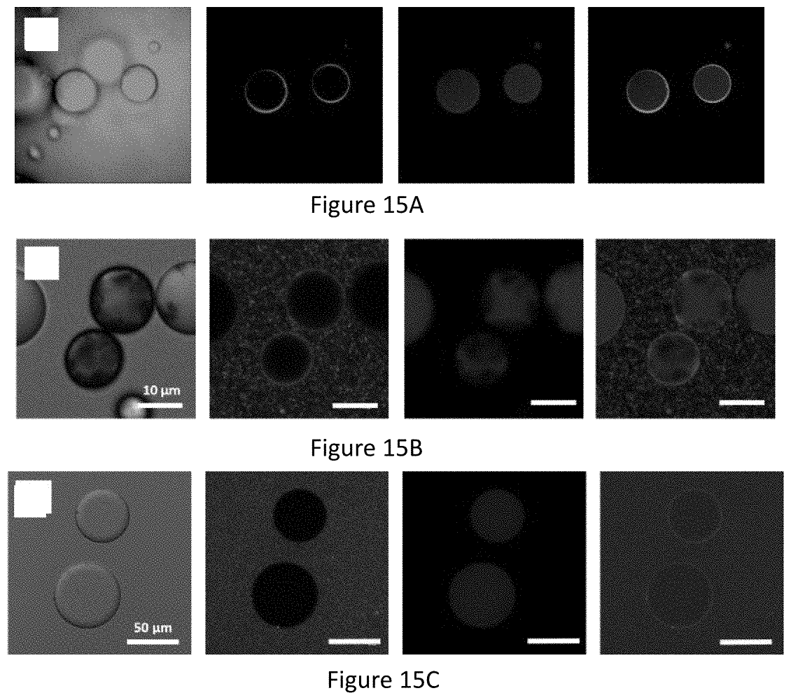

To visibly locate the MWCNTs at the o/w interface of the emulsions, we conjugated the fluorophore 6-aminofluorescein (6-AF, λ_{exc/em}=488/525 nm) to the free COOH— groups of carboxyl functionalized MWCNTs. We also added the lipid staining dye Nile red during emulsification to confirm the presence of an o/w emulsion. The locus of the MWCNTs at the o/w interface was then observed by CLSM. The occurrence of green fluorescent rings, constituting the periphery of the emulsion drop, demonstrated that the MWCNTs are indeed assembled mostly at the droplet interfaces (FIGS. 15A-C). As expected, the inside of the droplet was red colored, clearly evidencing the presence of an o/w emulsion. While the covalent binding of particles to a chromophore is a common technique in fluorescence imaging to reveal their locus in a specific system, 6-AF-functionalized MWCNTs might, however, show increased hydrophilicity as compared to the non-functionalized MWCNTs that were used throughout all other experiments. Furthermore, carboxylated MWCNTs may be greatly shortened in their tube length due to the harsh acidic preparation process [23]. To rule out, that these changes affect the amphiphilicity of the MWCNTs and their localization in the system, we further analyzed the behavior of pristine MWCNTs by CLSM. In addition, we compared our findings to a control sample, in which MWCNTs were completely absent and the Pickering emulsions stabilized by silica particles only. In these control experiments, a covalent binding of 6-AF was not possible, so that 6-AF as well as Nile Red were simply added to the corresponding mixtures prior to emulsification.

In case of the pristine MWCNT mixture, an identical green circular layer surrounding the oil droplet was visible (FIG. 15B). As well, large green clusters could be seen in the continuous water phase. We believe that these two phenomena resulted from physisorbed 6-AF molecules at the MWCNTs surface, likely via π-π stacking and van der Waals interactions. If so, the presence of non-fluorescent MWCNTs inside the oil droplet would suggest, that the shell is not permeable to any molecular mass transfer. As expected for the silica system, only the major water phase was homogenously green colored, but green ring structures completely missing (FIG. 15C).

### Example 3

### Morphology and Shell Thickness of the Colloidosomes

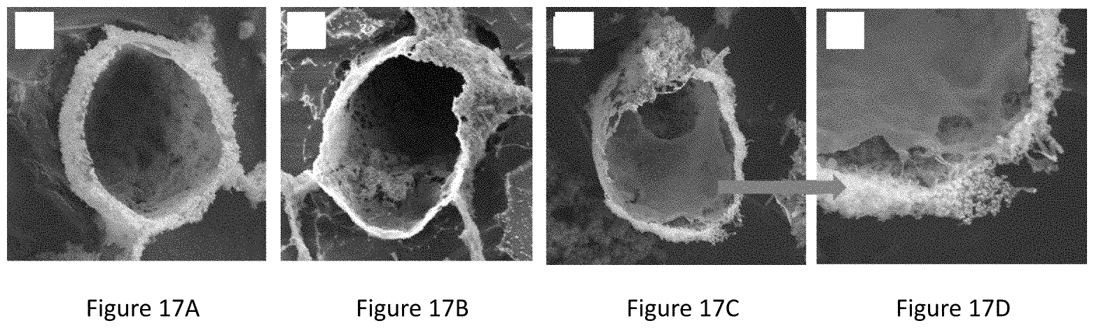

As evaporation of the volatile toluene proceeded during optical microscopy imaging, the droplets showed pronounced buckling and crumpling. This indicated that the oil droplets were encapsulated by a thin shell. The morphology and thickness of the colloidosome shells were thereupon determined by cryogenic field-emission SEM. The colloidosomes did not appear in all cases to be perfectly spherical and some rather showed an ellipsoidal shape (FIGS. 17A-D). Their sizes ranged from 6 to 10 um, which fits to the droplet sizes analyzed by optical microscopy.

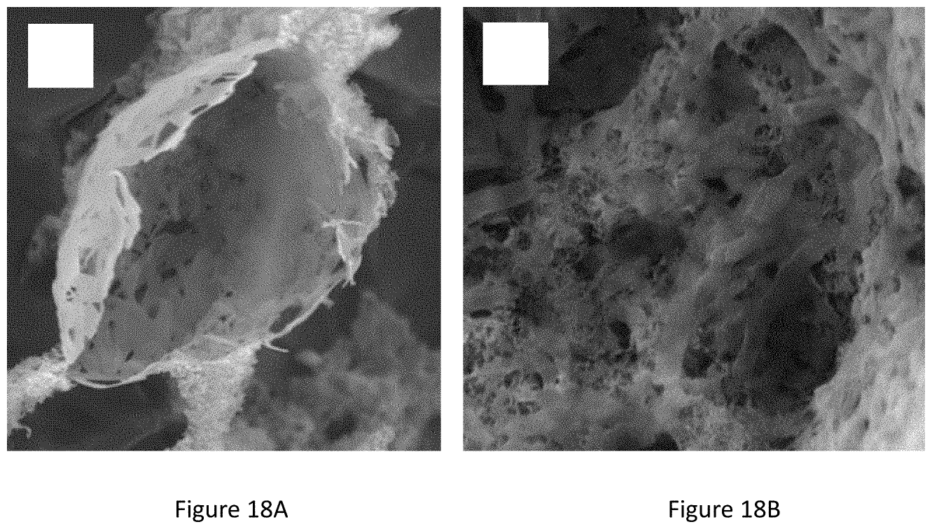

The shell forming layer was several hundreds of nanometers thick. The outer shell was composed of SiNPs aggregates. Because the nanoparticles are highly polydisperse, their structure at the o/w interface is likely to be amorphous, in contrast to systems with monodisperse particles. A smooth polymeric layer responsible for the shell formation can be clearly observed at the inner side of the capsules, especially illustrated in FIG. 17C and FIG. 17D. In between these two layers, MWCNTs could be observed. Most noticeable, however, were ribbon-like structures of several hundreds of nanometer thickness and varying length that formed at the o/w interface of some droplets (FIGS. 18A-B). These structures are sometimes more sometimes less densely ramified. Close inspection shows that the MWCNTs are fully incorporated into the polymer matrix.

### Example 4

### Highly Interconnected Porous Structures Form in Solid State

The ability of MWCNTs to directly improve the mechanical and electrical properties of composite materials, is closely coupled to their uniform and individual dispersion within the host matrix. MWCNT agglomerates that are caused by VAN DER WAALS interaction and intense MWCNT entangling throughout ceramic or polymeric matrices are thus a major barrier to success. The inventors therefore characterized the structure of the MWCNT/silica emulsions by HR-SEM in order to analyze the dispersibility and the interfacial compatibility of the MWCNTs in the final solid nanocomposite.

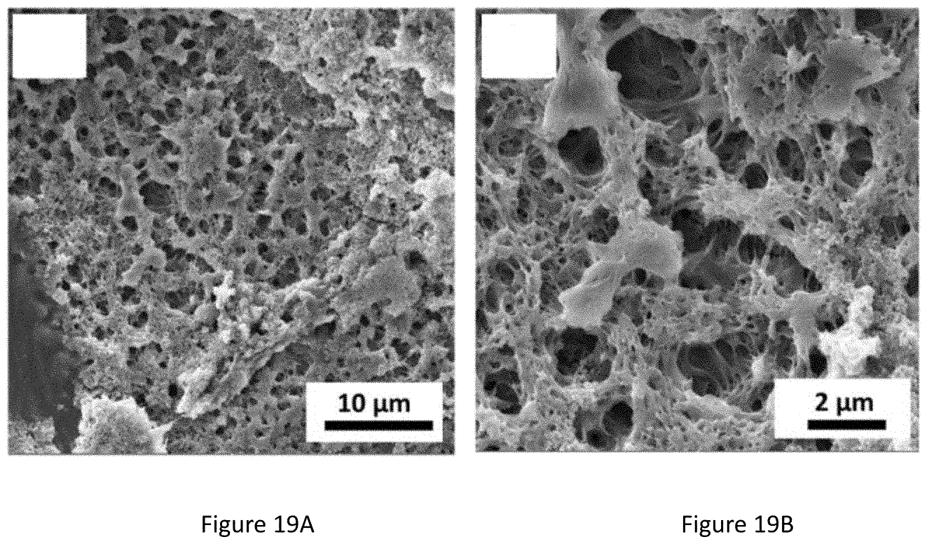

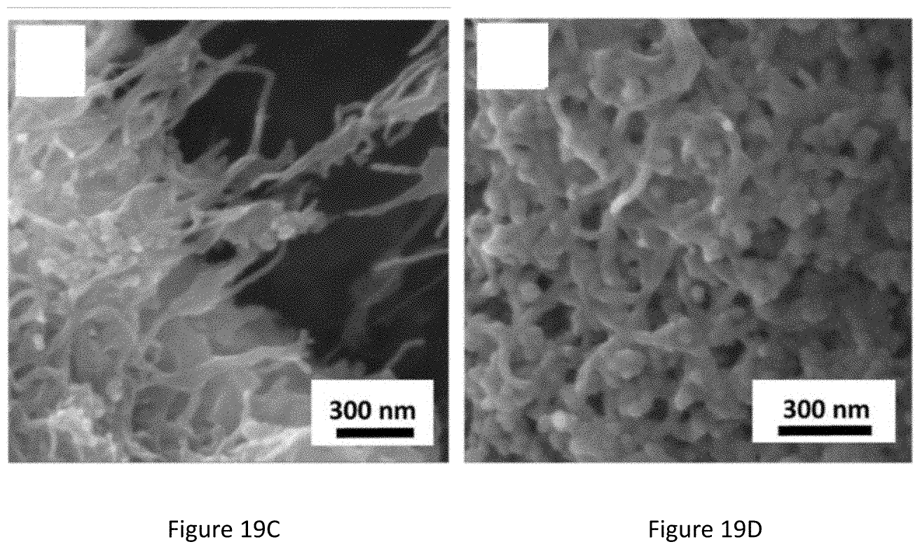

Under the severe high vacuum conditions in the SEM chamber, the shells ruptured and collapsed. This indicated that the pure scaffold is still too feeble to persist to the mechanical forces exerted upon drying and to maintain the microcapsules shape. SEM analysis however showed a hierarchical, highly open porous network structure, with pores of 1-2 μm in diameter (FIGS. 19A-D).

Smaller, secondary pores of few hundreds of nm were evident in the pore walls, interconnecting the neighboring larger cavities and showing potential for convective mass transfer. These pore throats probably resulted from the comparably thin polymeric layer that was formed between the droplets. Due to the density differences between the polysiloxane network and the aqueous continuous phase, shrinkage occurs causing ruptures in the polymer film at its thinnest point formed due to the stress exerted during the vacuum drying process. Cavities as well as pores throats were irregularly shaped. In some cases, the morphology resembled a fibrillary mesh. Well-dispersed and individualized MWCNTs could be clearly seen throughout the polymer pore walls. They were partly decorated by silica primary particles agglomerates (FIGS. 19C-D).

### Example 5

### Electrical Resistance Measurements of the MWCNT/Silica Films

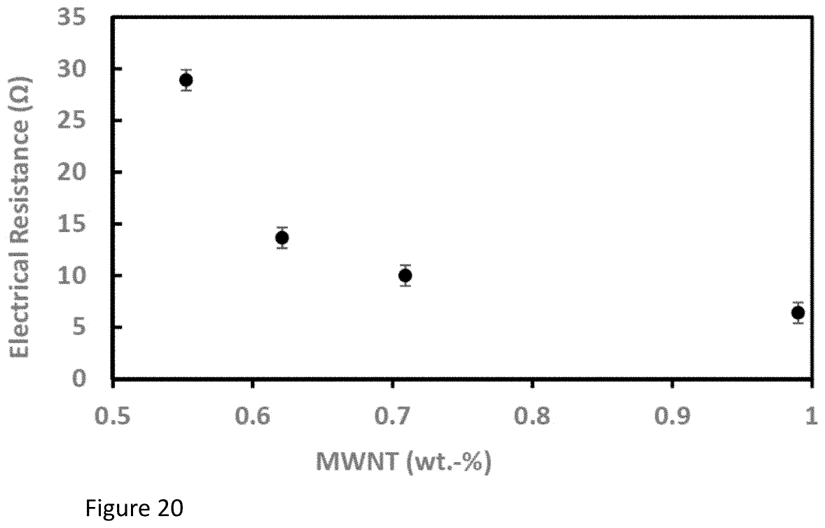

FIG. 20 shows the electrical resistance of the resulting films as a function of the MWCNT content. The experiments were performed for four samples and with 9 cycles at zero pressure and room temperature. An electrical resistance of 29Ω was obtained at a MWCNT content of 0.55 wt %. This value is relatively low and indicates that the resulting films are electrically insulating. As expected, the electrical resistance decreased by 77% to a value of 6.5Ω by increasing the MWCNT content to 0.99 wt %. Our results demonstrate that porous conductive nanocomposite films can be fabricated following the methodology developed in this study. By altering the MWCNT loading in a larger range, further fine tuning of the electrical resistance is expected.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A colloidosome comprising a shell encapsulating a core, wherein:
said shell comprises carbon particles in contact with a matrix comprising inorganic nano-particles covalently interconnected via a polymer;
said polymer comprises a hydrophilic stabilizing moiety and a hydrophobic stabilizing moiety.

2. The colloidosome of claim 1, having at least one parameter selected from (i) a diameter of said colloidosome is in a range between 1 μm and 300 μm; (ii) a thickness of said shell is in a range between 50 nm and 700 nm; (iii) said inorganic particles are selected from the group consisting of silica, aluminum oxide, iron (II/III) oxide, zirconium oxide, titanium oxide, clay, and any combination thereof; (iv) the core comprises an aqueous solution, a water-immiscible solvent, or is void.

3. (canceled)

4. (canceled)

5. (canceled)

6. The colloidosome of claim 1, wherein said hydrophobic stabilizing moiety is derived from a hydrophobic stabilizing precursor molecule, and said hydrophilic stabilizing moiety is derived from a hydrophilic stabilizing precursor molecule.

7. The colloidosome of claim 6, wherein said hydrophilic stabilizing precursor molecule and said hydrophobic stabilizing precursor molecule comprise a polymerizable group.

8. The colloidosome of claim 7, wherein said polymerizable group is reactive towards said inorganic nano-particles.

9. The colloidosome of claim 7, wherein said polymerizable group comprises a hydrolysable silane.

10. The colloidosome of claim 6, wherein said hydrophilic stabilizing precursor molecule is represented by Formula 1:
A-R—Si(X)₃, wherein
A is selected from the group consisting of amino, hydroxy, alkoxy, thiol, thioalkyl, carboxy, sulfate, nitro, phosphate, ester, and amide or any combination thereof;
R comprises an optionally substituted C5-C20 alkyl;
X is selected from the group consisting of halo, alkoxy, and aryloxy or any combination thereof.

11. The colloidosome of claim 6, wherein said hydrophobic stabilizing precursor molecule is represented by Formula 2:
B—R—Si(X)₃, wherein
B is selected from the group consisting of aryl, alkyl, cycloalkyl, heteroaryl, halo, ether, and a fused ring or any combination thereof;
R comprises an optionally substituted C5-C20 alkyl;
X is selected from the group consisting of halo, alkoxy, and aryloxy or any combination thereof.

12. The colloidosome of claim 6, wherein said hydrophilic stabilizing precursor molecule is 3-Aminopropyltriethoxysilane (APTES) and said hydrophobic stabilizing precursor molecule is dodecyltriethoxysilane (DTES).

13. The colloidosome of claim 1, wherein any one of: (i) a molar ratio between said hydrophilic stabilizing moiety and said hydrophobic stabilizing moiety within said colloidosome is between 5:1 to 1:5; and (ii) a w/w ratio of said carbon particles to said inorganic particles is in the range between 10:1 and 1:10.

14. (canceled)

15. The colloidosome of claim 1, wherein said carbon particles are selected from the group consisting of single-walled carbon nano-tubes, multi-walled carbon nano-tubes, nano-diamonds, carbon black, fullerene, and graphene or any combination thereof or any combination thereof.

16. A composition comprising a colloidosome and a solvent, wherein:
said colloidosomes comprising a shell encapsulating a liquid core;
said shell comprises carbon particles in contact with a matrix comprising inorganic nano-particles covalently interconnected via a polymer;
said polymer comprises a hydrophilic stabilizing precursor molecule and a hydrophobic stabilizing precursor molecule; and
said liquid core and said solvent independently comprise an aqueous solvent, or a water immiscible solvent.

17. (canceled)

18. The composition of claim 16, wherein any one of: (i) a concentration of said colloidosomes within said composition is between 10 and 90%, and (ii) said colloidosomes have a diameter size in the range of 1 μm to 300 μm.

19. (canceled)

20. The composition of claim 1, wherein said inorganic particles are selected from the group consisting of silica, aluminum oxide, iron (II/III) oxide, zirconium oxide, titanium oxide, clay, and any combination thereof.

21. The composition of claim 16, wherein said hydrophilic stabilizing precursor molecule is 3-Aminopropyltriethoxysilane (APTES) and said hydrophobic stabilizing precursor molecule is dodecyltriethoxysilane (DTES).

22. The composition of claim 16, wherein any one of: (i) a molar ratio between said hydrophilic stabilizing precursor molecule and said hydrophobic stabilizing precursor molecule within said colloidosome is between 5:1 to 1:5; and (ii) a w/w ratio of said carbon particles to said inorganic particles is in the range between 10:1 and 1:10.

23. (canceled)

24. (canceled)

25. A method for forming the composition of claim 16, comprising:
a. providing a first dispersion the comprising the inorganic nano-particles and an aqueous solvent;
b. mixing said first dispersion with a second dispersion comprising the carbon particles and the water immiscible solvent, thereby forming a mixture;
c. adding a hydrophilic stabilizing precursor molecule and a hydrophobic stabilizing precursor molecule to said mixture under suitable conditions, thereby forming a Pickering emulsion.

26. (canceled)

27. (canceled)

28. The method of claim 25, wherein any one of: (i) a concentration of said inorganic particles in the Pickering emulsion is between 0.2 and 10 wt %; (ii) a concentration of said carbon particles in the Pickering emulsion is between 0.01 and 10 wt %; (iii) said first dispersion/second dispersion ratio is in the range of 40:50 to 98:2; (iv) said suitable conditions comprise ultrasonication.

29. (canceled)

30. (canceled)

31. (canceled)

32. (canceled)

33. An article comprising: a substrate in contact with a coating layer, wherein said coating layer comprises the composition of claim 16.

34. The article of claim 33, wherein said substrate is selected from, a polymeric substrate, a glass substrate, a metallic substrate, a paper substrate, a brick wall, a sponge, a textile, a non-woven fabric, or wood, optionally wherein said coating is any one of (i) a coating characterized by pores in the range of 0.5 μm to 5 μm; and (ii) a coating characterized by electrical conductivity.

35. (canceled)

36. (canceled)

37. (canceled)

38. (canceled)

39. (canceled)
